(19) United States
(12) Patent Application Publication
(10) Pub. No.: US 2024/0369484 A1
(43) Pub. Date: Nov. 7, 2024

(54) METHOD AND SYSTEM FOR SPECTRAL IMAGING

(71) Applicant: Pentaomix Ltd., Rehovot (IL)

(72) Inventor: Boaz BRILL, Rehovot (IL)

(73) Assignee: Pentaomix Ltd., Rehovot (IL)

(21) Appl. No.: 18/682,137

(22) PCT Filed: Aug. 9, 2022
(86) PCT No.: PCT/IL2022/050872

§ 371 Date: Feb. 8, 2024

Related U.S. Application Data
(60) Provisional application No. 63/260,071, filed on Aug. 9, 2021.

(51) Int. Cl. G01N 21/64; G01N 21/27; G01N 21/45

(52) U.S. Cl. CPC G01N 21/6428; G01N 21/276; G01N 21/45; G01N 21/6458; G01N 2021/6423; G01N 2021/6441; G01N 2021/6465

(57) ABSTRACT

A method of imaging a sample comprises serially illuminating the sample by a plurality of light beams, each having a different central wavelength. The method also comprises: serially acquiring from the sample image data by an imager, wherein the image data represent optical signals received from the sample responsively to the plurality of light beams. The method also comprises shifting a field-of-view of the sample relative to the imager, repeating the serial illumination and the image data acquisitions for the shifted field-of-view, and generating a spectral image of the sample using image data acquired by the imager at a plurality of field-of-views for each of the plurality of light beams.

### RELATED APPLICATION

This application claims the benefit of priority of U.S. Provisional Patent Application No. 63/260,071 filed on Aug. 9, 2021, the contents of which are incorporated herein by reference in their entirety.

### FIELD AND BACKGROUND OF THE INVENTION

The present invention, in some embodiments thereof, relates to imaging and, more particularly, but not exclusively, to a method and system for spectral imaging.

Most currently available cancer treatments are known to be effective for only approximately 20% of the patients, while most patients do not respond to treatment. With no ability to identify in advance which of the patients will respond to any given drug, treatment is mostly based on trial-and-error and several drugs may be tested on any patient. This situation leads, in many cases, to loss of life, poor quality of life of the patients due to unnecessary side effects and inefficient use of resources.

For a few drugs, companion diagnostics is available, enabling to identify those patients for whom the likelihood to respond to treatment is higher than others. Most of these companion diagnostics are based on the expression levels of specific biomarkers, e.g., PD-1 or HER2. These biomarkers are typically identified in the histological examination of a biopsy, following specific staining using an antibody, utilizing immunohistochemical (IHC) methods.

Known in the art are histological techniques that employ spectral imaging [Y. Garini and E. Tauber, Spectral Imaging: Methods, Design, and Applications in Biomedical Optical Imaging Technologies: Design and Applications, edited by R. Liang (Springer, Heidelberg, 2013)]. Spectral imaging is a technique in which a spectrum is measured for each pixel of an imager. The resulting dataset is three-dimensional (3D) in which two dimensions are parallel to the imager plane and the third dimension is the wavelength. Such dataset is known as a “spectral image” which can be written as I(x, y ,λ), where x and y are the position in the imager plane, λ the wavelength, and I is the intensity at each point and wavelength.

Among the different spectral imaging methods, some methods use Fourier Transform (typically known as FTIR for Fourier Transform InfraRed), and include the collection of an interferogram (signal vs. phase delay) for each pixel in the Field of View (FoV) which is then transformed to the spectral domain by the use of a Fourier transform.

U.S. Pat. No. 5,539,517 discloses an FTIR-based spectral imaging system. The system utilizes an interferometer that serves as a variable spectral filter. The phase delay between the two arms of the interferometer is changing along one of the axes of the FoV. A full interferogram for each point in the object is obtained by scanning the object along this axis and collecting the data from the same point in the object over different images, taken at different parts of the FoV. These interferograms are then be transformed, e.g., using FFT, into spectra, creating a spectral image.

Shmilovich et. al, Scientific Reports, (2020) 10:3455 discloses a similar scanning method to obtain spectral images, except that in this method the variable spectral filter used is based on a wedged liquid crystal arrangement.

International publication No. WO2021/014455 A1 discloses a family of different spectral imaging methods useful for obtaining spectral imaging of samples stained with haematoxylin and eosin (H&E) for the purpose of identifying individual cancer cells.

U.S. Pat. No. 11,300,799 B2 discloses an optical device including two attached prisms and a beam splitter at an interface region between the two prisms. The device serves as a Michelson-type interferometer wherein a beam emitted by a source propagates through the prisms along two different optical paths before reaching a detector.

### SUMMARY OF THE INVENTION

According to an aspect of some embodiments of the present invention there is provided a method of imaging a sample. The method comprises: serially illuminating the sample by a plurality of light beams, each having a different central wavelength. The method also comprises: serially acquiring from the sample image data by an imager, wherein the image data represent optical signals received from the sample responsively to the plurality of light beams. The method also comprises shifting a field-of-view of the sample relative to the imager, repeating the serial illumination and the image data acquisitions for the shifted field-of-view, and generating a spectral image of the sample using image data acquired by the imager at a plurality of field-of-views for each of the plurality of light beams.

According to some embodiments of the invention the serial acquisition of image data is while the field-of-view is static.

According to some embodiments of the invention the serial acquisition of image data is while the field-of-view varies.

According to some embodiments of the invention the sample contains a plurality of fluorophores each having a different emission spectrum, and wherein a spectral bandwidth of at least one of the light beams is selected to excite at least two different fluorophores.

According to some embodiments of the invention the illuminating is via a pinhole, and the acquiring is via a beam stop configured to reduce contribution of the light beams to the image data.

According to some embodiments of the invention the illuminating is via beam splitter configured and positioned to reflect the light beams and transmit the optical signals or vice versa.

According to some embodiments of the invention the method comprises collimating the optical signal, wherein the illuminating is by a plurality of light sources arranged peripherally with respect to an optical axis defining the collimation.

According to some embodiments of the invention the method comprises directing a portion of the optical signal to a spectrometer for measuring a local spectrum of each optical signal, comparing the measured spectra to a local spectrum of the spectral image, and generating a report pertaining to the comparison.

According to some embodiments of the invention the method comprises directing a portion of the optical signal to an additional imager for generating also a non-spectral image.

According to some embodiments of the invention the method comprises projecting an imageable pattern onto the sample, imaging the pattern by the additional imager, and calculating a defocus parameter based on the image of the pattern.

According to some embodiments of the invention the pattern is projected such that different parts of the imageable pattern are focused on the sample at different distances from an objective lens through which the image data are acquired.

According to some embodiments of the invention the pattern is projected at a wavelength outside a wavelength range encompassing the optical signals.

According to some embodiments of the invention the method comprises passing the optical signal through an optical system characterized by varying optical transmission properties.

According to an aspect of some embodiments of the present invention there is provided a method of imaging a pathological slide stained with multiple stains having different spectral properties. The method comprises: executing the method as delineated above and optionally and preferably as further detailed below; analyzing the spectral image for a relative contribution of each stain; and generating a displayable density map of the stains based on the relative contribution.

According to some embodiments of the invention the method comprises spatially segmenting the spectral image into a plurality of segment, wherein at least one of the segments corresponds to a single biological cell, and wherein the density map is a map of the single biological cell.

According to some embodiments of the invention the method comprises calculating an average density of each stain in the cell, thereby providing an expression profile for the cell.

According to some embodiments of the invention the method comprises classifying the cell according to the expression profile.

According to some embodiments of the invention the method comprises repeating the calculation of the average density and the classification for each of a plurality of cells.

According to some embodiments of the invention the method comprises classifying the pathological slide based on geometrical relationships between cells classified into different cell classes.

According to an aspect of some embodiments of the present invention there is provided a system for imaging a sample. The system comprises an illumination system configured for serially illuminating the sample by a plurality of light beams, each having a different central wavelength; an imager, configured for acquiring image data from the sample, the image data representing optical signals received from the sample responsively to the plurality of light beams; a stage, configured for shifting a field-of-view of the sample relative to the imager; a controller, configured to control the stage to shift the field-of-view in steps, and to control the illumination system and the imager such the illumination system serially illuminates the sample by the light beams and the imager serially acquires the image data; and an image processor configured to generate a spectral image of the sample using image data acquired by the imager at a plurality of field-of-views for each of the plurality of light beams.

According to some embodiments of the invention the system comprises a pinhole configured to reduce a solid angle of the light beams, and a beam stop configured to reduce contribution of the light beams to the image data.

According to some embodiments of the invention the system comprises a beam splitter configured and positioned to reflect the light beams and transmit the optical signals or vice versa.

According to some embodiments of the invention the system comprises a collimating lens for collimating the optical signal, wherein the illuminating system comprises a plurality of light sources arranged peripherally with respect to an optical axis of the collimating lens.

According to some embodiments of the invention the system comprises a spectrometer for measuring a local spectrum of each optical signal, wherein the image processor is configured to compare the measured spectra to a local spectrum of the spectral image, and to generate a report pertaining to the comparison.

According to some embodiments of the invention the system comprises an additional imager for generating also a non-spectral image of the sample using the optical signal.

According to some embodiments of the invention the system comprises a projector for projecting calibration pattern onto the sample in a manner that the calibration pattern is also imaged by the additional imager, wherein the image processor is configured to process the image of the calibration pattern so as to calculate a defocus parameter.

According to some embodiments of the invention the projector is configured to generate the calibration pattern at a wavelength outside a wavelength range encompassing the optical signals.

According to some embodiments of the invention the system comprises an optical system positioned on an optical path between the sample and the imager and being characterized by varying optical transmission properties.

According to some embodiments of the invention the optical system is characterized by temporally varying optical transmission properties.

According to some embodiments of the invention the optical system is characterized by spatially and temporally varying optical transmission properties.

According to some embodiments of the invention the optical system is characterized by spatially varying optical transmission properties.

According to some embodiments of the invention the spatially varying optical transmission properties vary discretely.

According to some embodiments of the invention the spatially varying optical transmission properties vary continuously.

According to some embodiments of the invention the optical system comprises a Sagnac interferometer.

According to some embodiments of the invention the Sagnac interferometer comprises: two attached prisms forming an asymmetric monolithic structure having an entry facet at one prism and an exit facet at another prism; and a beam splitter, engaging a portion of an attachment area between the prisms and being configured for splitting the optical signal entering through the entry facet into two secondary optical signals exiting through the exit facet; wherein a size of the beam splitter is selected to ensure that optical paths of the secondary optical signals impinge on the attachment area both at locations engaged by the beam splitter and at locations not engaged by the beam splitter.

According to an aspect of some embodiments of the present invention there is provided a Sagnac interferometer. The Sagnac interferometer comprises: two attached prisms forming an asymmetric monolithic structure having an entry facet at one prism and an exit facet at another prism; and a beam splitter, engaging a portion of an attachment area between the prisms and being configured for splitting an optical signal entering through the entry facet into two secondary optical signals exiting through the exit facet; wherein a size of the beam splitter is selected to ensure that optical paths of the secondary optical signals impinge on the attachment area both at locations engaged by the beam splitter and at locations not engaged by the beam splitter.

According to some embodiments of the invention the two prisms are identical but are attached offset to one another thus ensuring the asymmetry.

According to some embodiments of the invention the two prisms have different shapes thus ensuring the asymmetry.

According to some embodiments of the invention the monolithic structure comprises a spacer at the attachment area, spaced apart from the beam splitter away from any of the optical paths.

According to some embodiments of the invention the spacer is made of the same material and thickness as the beam splitter.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system imaging a sample, according to some embodiments of the present invention;

FIG. 2 is a schematic illustration of a sequential image acquisition process, according to some embodiments of the present invention;

FIG. 3 is a schematic illustration of a system imaging a sample, according to embodiments of the invention in which a Sagnac interferometer is employed;

FIG. 4 is a schematic illustration of a system imaging a sample, according to embodiments of the invention in which a pinhole is employed for reducing a solid angle of light beams illuminating the sample;

FIG. 5 is a schematic illustration of a system imaging a sample, according to embodiments of the invention in which a peripheral illumination system is employed for illuminating the sample;

FIG. 6 is a flowchart diagram illustrating an exemplified sample analysis protocol according to some embodiments of the present invention;

FIG. 7 is a schematic illustration of a system imaging a sample, according to embodiments of the invention in which the system also comprises a spectrometer and/or an additional imager;

FIG. 8 is a schematic illustration of a system imaging a sample, according to embodiments of the invention in which the system employs a pattern that is projected onto the sample;

FIG. 9 is a graph showing show normalized emission spectra of several fluorophores that can be used with the system of the present embodiments;

FIG. 10 is a schematic illustration of an optical system which comprises a monolithic Sagnac interferometer, according to some embodiments of the present invention;

FIG. 11 is a schematic illustration showing more details of the monolithic Sagnac interferometer shown in FIG. 10, according to some embodiments of the present invention;

FIG. 12 is a schematic illustration showing more details of the optical system shown in FIG. 10;

FIG. 13 is a schematic illustration showing an exit facet of the monolithic Sagnac interferometer, according to some embodiments of the present invention;

FIGS. 14A and 14B show results of ray tracing simulations performed for the monolithic Sagnac interferometer in a configuration of the interferometer in which the angle of a beam splitter is 45.0333°, according to some embodiments of the present invention;

FIGS. 15A and 15B are schematic illustrations of the monolithic Sagnac interferometer according to embodiments of the invention in which the interferometer comprises two prisms that are attached in an offset relation to one another, where FIG. 15B is a magnified view of the dotted section in FIG. 15A;

FIGS. 16A-C show results of ray tracing simulations performed for different propagating distances of optical signals before entering the monolithic Sagnac interferometer, according to some embodiments of the present invention;

FIG. 17 is a schematic illustration of the monolithic Sagnac interferometer, in embodiments of the invention in which the interferometer comprises a spacer;

FIG. 18 is a schematic illustration of a monolithic Michelson interferometer;

FIGS. 19A-D show results of ray tracing simulations performed for a monolithic Michelson interferometer (FIGS. 19A-B), and a monolithic Sagnac interferometer (FIGS. 19C-D), without (FIGS. 19A and 19C) and with (FIGS. 19B and 19D) simulated manufacturing errors; and

FIG. 20 is flowchart diagram of a method suitable for imaging a sample according some embodiments of the present invention;

### DESCRIPTION OF SPECIFIC EMBODIMENTS OF THE INVENTION

The present invention, in some embodiments thereof, relates to imaging and, more particularly, but not exclusively, to a method and system for spectral imaging.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The Inventor found that conventional spectral imaging techniques are limited in the number of different stains or fluorochromes that can be measured, because the number of different emission spectra that can be separated within a typical wavelength range of, e.g., 400-800 nm, is practically limited to about 8. The Inventor has therefore devised a technique that allows measuring and analyzing a large number of different stains or fluorochromes without compromising on the accuracy of the measurement. This is particularly useful in analyses of pathological slides that includes many different types of cells.

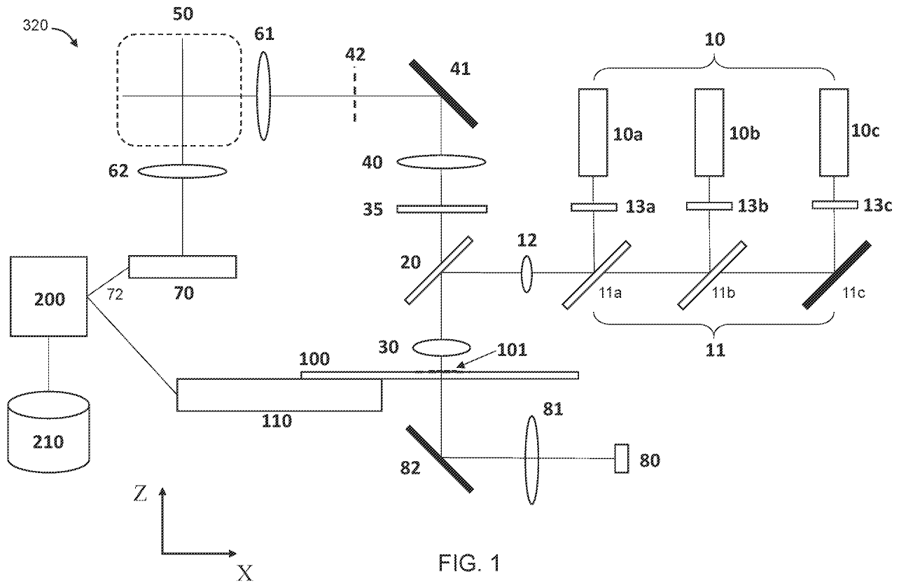

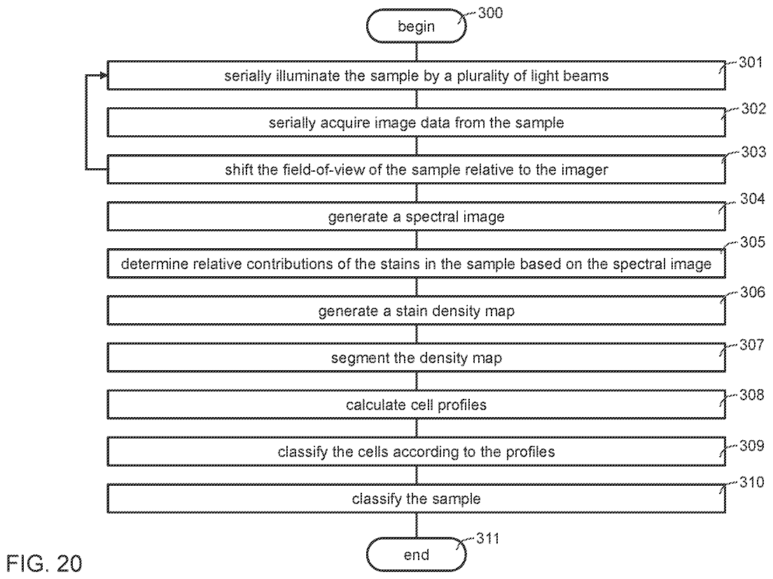

Referring now to the drawings, FIG. 20 is a flowchart diagram of a method suitable for imaging a sample according to various exemplary embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed. A system 320 suitable for executing selected operations of this method are illustrated at least in FIGS. 1, 3-5, 7 and 8.

The sample 101 to be imaged can by of any type. Preferably, the sample comprises is a slide, carrying cells and/or tissue for in-vitro imaging. The sample 101 can alternatively be a live tissue. Still alternatively, the sample can be non-biological, such as, but not limited to, a semiconductor wafer, and a printed object, e.g., a printed circuit board.

More preferably, the samples 101 is microscope slide. The sample 101 can be placed on a carrier substrate 100, which is optionally and preferably made transparent. In some embodiments of the present invention sample 101 is a slide suitable for histology, and optionally and preferably immunohistochemistry (IHC).

Sample 101 is preferably stained with at least one stain. More preferably, but not necessarily, the sample is stained with a plurality of stains, for example, at least 5 or at least 10 or at least 15 different stains. The staining can be using any staining technique known in the art.

As used herein, the term “stain” refers to a colorant, either fluorescent, luminescent and/or chromogenic and further to reagents or matter used for effecting coloration.

Representative example stains suitable for the present embodiments include, without limitation, a direct immunohistochemical stain, a secondary immunohistochemical stain, a histological stain, a immunofluorescence stain, a DNA ploidy stain, a nucleic acid sequence specific probe, a dye, an enzyme, a non-organic nanoparticle and any combination thereof.

As used herein, the term “immunohistochemical stain” refers to colorants, reactions and associated reagents in which a primary antibody which binds a cytological or receptor (e.g. protein receptor) marker is used to directly or indirectly (via “sandwich” reagents and/or an enzymatic reaction) stain the biological sample examined. Immunohistochemical stains are in many cases referred to in the scientific literature as immunostains, immunocytostains, immunohistopathological stains, etc.

As used herein, the term “histological stain” refers to any colorant, reaction and/or associated reagents used to stain cells and tissues in association with cell components such as types of proteins (acidic, basic), DNA, RNA, lipids, cytoplasm components, nuclear components, membrane components, etc. Histological stains are in many cases referred to as counterstains, cytological stains, histopathological stains, etc.

As used herein, the term “DNA ploidy stain” refers to stains which stoichiometrically bind to chromosome components, such as, but not limited to, DNA or histones. When an antibody is involved, such as anti-histone antibody, such stains are also known as DNA immunoploidy stains.

In some embodiments of the present invention the method receives the sample 101 already after it has been stained, and in some embodiments of the present invention the method receives the sample 101 before staining. In the latter embodiments, the imaging method 300 described below is preceded by an operation in which sample 101 is stained. The staining can be done by any technique known in the art, either by an automated staining system or manually. The staining is optionally and preferably executed using multiple stains, either simultaneously in a single staining process or in two or more staining processes. For example, the staining can include a first staining processes in which the sample is stained using a plurality of different fluorescent stains as known in the art, and a second staining processes in which the stained sample is further stained with one or more non-fluorescent stains, such as, but not limited to, H&E stain, Periodic acid-Schiff stain, and a Romanowsky stain. When two or more staining processes are employed, they can be executed in any order of execution.

The method begins at 300 and optionally and preferably continues to 301 at which the sample 101 is illuminated by a plurality of light beams, each having a different central wavelength. The light beams can be generated by an illumination system 10 as further detailed hereinbelow, and can optionally be redirected from the illumination system 10 to the sample 101 by means of optical redirecting elements 11 and 20. The light beams from system 10 are preferably directed to the imaged side of the sample.

The central wavelengths of the light beams are preferably in the visible range (e.g., from about 400 nm to about 700 nm), but use of infrared or ultraviolet light is also contemplated. The bandwidth of each light beam is preferably less than 30 nm, or less than 20 nm, e.g., 15 nm or less.

Sample 101 can be stained with a plurality of fluorophores each having a different emission spectrum. In some embodiments the spectral bandwidth of at least one of the light beams is optionally selected to excite at least two different fluorophores. In some embodiments, two or more fluorophores have different excitation spectra. In some embodiments, two or more fluorophores have the different excitation spectra but similar (e.g., within 10 nm or 10 nm or from each other) emission spectrum.

Typical central wavelengths that can be employed at 301 include, without limitation, from about 400 nm to about 410 nm, e.g., about 405 nm, and/or from about 475 nm to about 500 nm, e.g., about 488 nm, and/or from about 525 nm to about 540 nm, e.g., about 532 nm, and/or from about 625 nm to about 640 nm, e.g., about 633 nm.

In some embodiments of the present invention the sample 101 is also illuminated by a light beam having a broader bandwidth, e.g., a bandwidth of at least 100 nm, referred to herein as a bright field (BF). Such a light bean can generated by an additional light source 80. For example, the bright field can be polychromatic (e.g., white) light having a plurality of wavelengths spanning across the wavelength range 400-700 nm. The light beam from light source 80 is preferably directed to a side of the sample in that is opposite to the imaged side (transmission mode).

Also contemplated, are embodiments in which one or more of the light sources of illumination system 10 generate light beams selected for facilitating imaging in reflectance mode, in either bright or dark field modes.

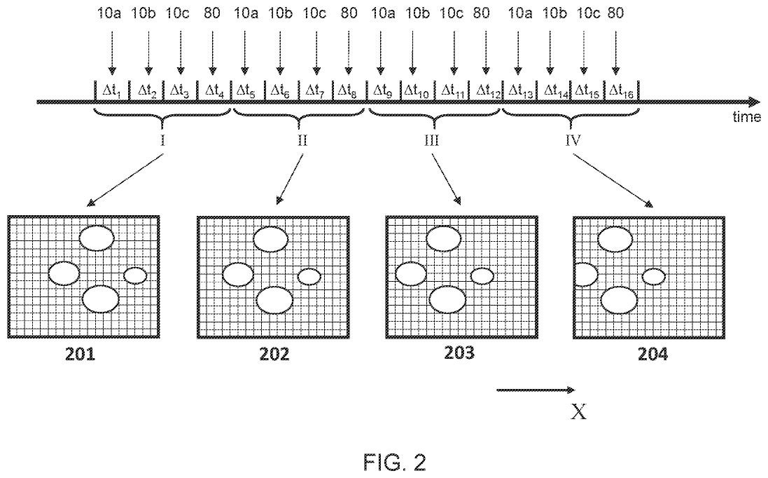

The illumination 301 is serial in the sense that during each time-period of a sequence of n time periods, the sample 101 is illuminated by light having different spectral properties. The sequence of n time periods can define an illumination cycle, which in various exemplary embodiments of the invention is executed repeatedly. In the simplest case, during each time period the sample 101 is illuminated by light beam having a single central wavelength, e.g., a light beam generated by a single monochromatic light source. A representative example of such a serial illumination process is schematically illustrated in the upper part of FIG. 2, showing a time axis with a plurality of time-periods Δt₁, Δt₂, and so on. In the representative example, which is not to be considered as limiting, the sequence of time periods includes four time periods (n=4 in the above formalism), so that during a first time period Δt₁, a first light beam is generated (e.g., using a first light source 10a of illumination system 10), during a second time period Δt₂, a second light beam is generated (e.g., using a first light source 10b of illumination system 10), during a third time period Δt₃, a third light beam is generated (e.g., using a first third light source 10c of illumination system 10), and during a fourth time period Δt₄, a bright field beam is generated (e.g., using additional light source 80). In the illustration of FIG. 2, the four time periods Δt₁-Δt₄ form an illumination cycle I. The serial illumination can be repeated, for example, in a cyclic manner, as illustrated in FIG. 2.

It is to be understood however, that more than one light source can be used during a given time-period, provided the spectral characteristics of the light beam that illuminates sample 101 is different at each of the time-periods within the illumination cycle. As a representative and non-limiting example, consider an illumination cycle that includes five time periods, wherein during the first time period, sample 101 is illuminated by a light beam from source 10a, during the second time period, sample 101 is illuminated by a light beam generated by activating sources 10a and 10b together, and during each of the third, fourth and fifth time periods, sample 101 is illuminated by a light beam generated by a different one of sources 10b, 10c, and 80.

The method continues to 302 at which image data are serially acquired from the sample by an imager 70. Operations 301 and 302 are optionally and preferably executed at the same time. The image data acquired at 302 represent optical signals received from the sample 101 responsively to light beams. For example, when the sample is stained with fluorophores, the light beams stimulate the fluorophores and the optical signals are the corresponding fluorescence emissions. Imager 70 preferably acquires image data following the illumination by each of the light beam without shifting field-of-view of the sample relative to imager while switching between the light beams. The field-of-view of the sample relative to the imager is illustrated at the lower part of FIG. 2. As shown, the field-of-view remains static throughout the cycle. For example, frame 201 represents the field-of-view during all four successive time-periods Δt₁-Δt₄ that form illumination cycle I.

Alternatively, imager 70 can acquire image data while the field-of-view varies sufficiently slowly relative to the time durations within the illumination cycle. In these embodiments, the time periods within each cycle are sufficiently short. For example, the time periods within each cycle can be less than the time it the field-of-view to be shifted by the amount of one pixel size.

At 303 the field-of-view of the sample relative to the imager is optionally and preferably shifted. From 303 the method loops back to 301 and repeats the executions of 301 and 302 for the shifted field-of-view. The loopback is preferably executed more than once. Referring again to FIG. 2, frame 202 represents the field-of-view during illumination cycle II (time-periods Δt₅-Δt₈), frame 203 represents the field-of-view during illumination cycle III (time-periods Δt₉-Δt₁₂), and frame 204 represents the field-of-view during illumination cycle IV (time-periods Δt₁₃-Δt₁₆). While FIG. 2 illustrates four cycles with four time-periods at each cycle, it is to be understood that the method can employ any number of cycle and any number of time-periods per cycle.

The shift at 303 is preferably by an amount that is larger than 1 pixel, e.g., 2-200 pixels or more preferably 10-200 pixels.

Denoting the number of illuminations per cycle by N and the number of cycles by M, the dataset acquired by imager 70 over operations 301-303 includes N·M images acquired in a time-interlaced manner wherein the set of images acquired for the first light beam is interlaced with the set of images acquired for the second light beam and so on. Broadly speaking, the same N·M images can be acquired without interlacing, for example, by illuminating the sample only by the first light beam and acquiring images at M different field-of-views, then illuminating the sample only by the second light beam and again acquiring images at the same M different field-of-views, and so on. However, it was found by the Inventors that the acquisition in a time-interlaced manner is advantageous because it reduces overall measurement time and ensures an accurate overlap between all the images acquired at a given field-of-view.

The data acquisition by imager 70 is executed in a manner that provides sufficient data to collect a sufficiently long data vector (e.g., a data vector having 6 or more intensity values, or 10 or more intensity values, or 20 or more intensity values, or 30 or more intensity values) for each pixel in imager 70 so as to allow the generation of a spectral image at 304. This is optionally and preferably ensured by passing the optical signal from the sample through an optical system 50 that is characterized by varying optical transmission properties. The optical transmission properties preferably include a spectral band, but may alternatively or additionally also be a polarization and/or intensity. The variation of the optical transmission properties can be temporal or spatial.

When the variation is temporal, optical system 50 preferably has a different optical transmission property (or a different set of optical transmission properties) for each illumination cycle. This allows imager 70 to collect image data in which each pixel has a set of values each describing a light intensity of a different wavelength component of the optical signal. Representative examples of optical systems suitable for use as optical system 50 in case of a temporal variations, including, without limitation, a filter wheel which mechanically switches between optical filters having different transmission properties, a liquid crystal system which changes its optical transmission properties as a function of voltage applied thereto, and an acousto-optic variable filter. In embodiments in which the variation is temporal, operation 302 is preferably executed only in case in which the field-of-view that is provided to imager 70 is smaller than the field-of-view of sample 101 that is to be imaged. In cases in which the field-of-view that is provided to imager 70 encompasses sample 101 in its entirety, or cases in which the field-of-view that is provided to imager 70 encompasses a region-of-interest within sample 101, operation 302 can be skipped.

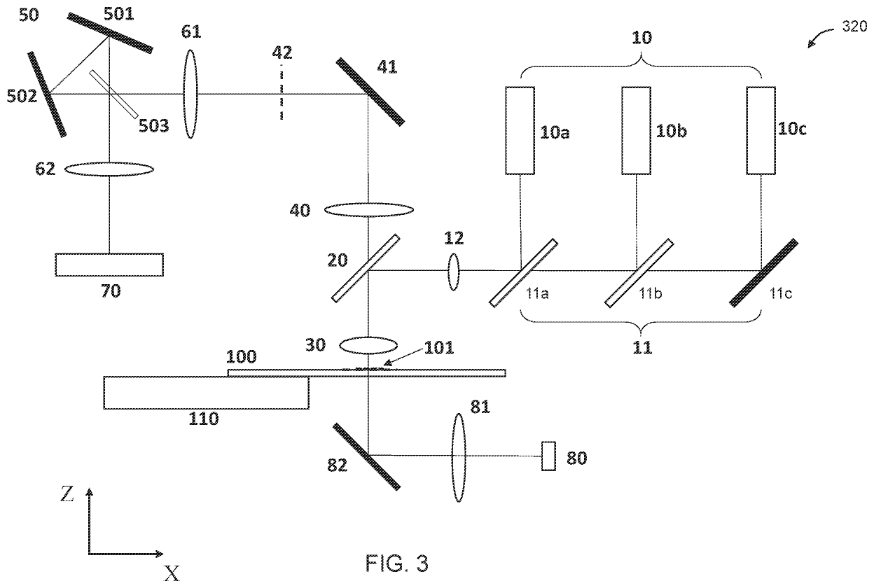

When the variation is spatial, optical system 50 has preferably has a optical transmission property (or a different set of optical transmission properties) which vary as a function of a location over the surface of optical system 50 or as a function of the entry angle of each light ray of the optical signal into optical system 50. In these embodiments, optical system 50 can be, for example, an interferometer, preferably a Sagnac interferometer, and the data vector at each pixel is an interferogram generated by the interferometer. A representative illustration of system 320 in embodiments in which optical system 50 comprises a Sagnac interferometer is provided in FIG. 3.

In embodiments in which optical system 50 can is an interferometer, the optical signal from the sample 101 is split into two secondary optical signal that propagate along the arms of the interferometer and are eventually interfere with each other at the exit of the interferometer. The arms of the interferometer are configured so that there is a different optical path length along each arm, and the interference pattern of the two secondary optical signals depends of the path length difference and on the wavelength of the optical signal from the sample. The interferometer effectively provides a variable spectral transmission function which depends on the entrance angle of the optical signal to the interferometer. For example, for an optical signal that is monochromatic and uniform across the sample, the spectral transmission function is a cosine function across the field of view, because different points across the field of view enter the interferometer at different angles. Generally the spatial interference pattern relates to the Fourier transform of the optical signal.

Upon exiting the interferometer, the recombined secondary optical signals are imaged by the imager 70, such that each light ray within the recombined signals arrive at a different sensing element thereof. This provides an image of the sample that is modulated by the interference pattern created by the interferometer. Thus, the spectral transmission factor imposed by the interferometer on the signal from any point in the sample depends on its location within the field-of-view. Since the image data is acquired over multiple field-of-views, the intensity of a plurality of wavelength components of the optical signal can be measured for each point in the sample, e.g. by means of Fast Fourier Transform (FFT), taking into account the characteristic transmission function of the interferometer as a function of the entrance angle.

The advantages of using an interferometer and obtaining the spectrum by Fourier transform is its superior signal to noise in the context of low signals, which is a result of the fact that almost all the emitted optical signal is used for the measurement process, and is not filtered out. This effect, known as Fellgett's multiplex advantage, is particularly advantageous in the context of fluorescence, because fluorescence is characterized by low-intensity signals.

The spectral image provided at 304 thus comprises data arranged over a plurality of pixels each storing a plurality of a set of intensity values which respectively correspond to a set of wavelength components of the optical signal and therefore represent the local spectrum of the optical signal at that pixel.

In some embodiments of the present invention the method proceeds to 305 at which the spectral image is analyzed to determine a relative contribution of each stain in the sample. This can be done, for example, by binning the spectrum at each pixel based on the characteristic emission spectra of the stains that were used to stain the sample. The method can then proceed to 306 at which a displayable density map of the stains is generated based on relative contribution. The density map can be displayed on a display device or transmitted to a remote location for displaying at the remote location.

In some embodiments of the present invention the method proceeds to 307 at which the density map is spatially segmented into a plurality of segments, wherein at least one of the segments, more preferably each of at least a portion of the plurality of segments, corresponds to a single biological cell. The segmentation can be done based on data associated with a portion of the stains in sample 101. Specifically, the segmentation can be done based on parts of the density map that corresponds to a predetermined portion of the spectrum that is stored in each pixel of the spectral image. In some embodiments of the present invention the segmentation is done based on data associated with a single stain in sample 101. For example, the segmentation is done based on image data that correspond to a non-fluorescent stain as imaged while sample 101 is illuminated using bright field source 80 (e.g., an H&E stain) and not on any image data that correspond to stains that are imaged while sample 101 is illuminated using one of the light sources of illumination system 10.

In embodiments in which operation 305 is executed, the method preferably generates at least one density map of a single biological cell. In some embodiments of the present invention the method proceeds to 308 at which an average density of each stain in the cell is calculated to providing an expression profile for the cell. Preferably, the profile is calculated for more than one cell, more preferably for at least the majority of the cells in the sample.

The method can then optionally and preferably proceed to 309 at which the cell(s) is/are classified according to the calculated expression profile(s). This can be done by comparing the profile of each cell to a database of expression profiles, or by comparing the profiles among the cells of the sample. Optionally, the classification includes identification of the cell, for example, identifying whether the cell is a cancer cell or an immune system cell. Such identification can be done based on a similarity between the calculated profile and the profile of previously identified cell classes or cell types which may be stored in the database.

In some embodiments of the present invention the method proceeds to 310 at which the sample is classified based on geometrical relationships between cells that are classified into different cell classes. For example, based on geometrical relationships the sample can be classified as cancerous or benign, and may optionally classified according to the grade of the cancer.

The method ends at 311.

Before providing a further detailed description of the method and system of the present embodiments, as delineated hereinabove, attention will be given to the advantages and potential applications offered thereby.

In many conventional systems, only a single biomarker is stained per slide. In some cases, multiple biomarkers are analyzed by staining successive slides with different IHC biomarkers, however in this method the co-localization of the biomarkers is lost as different slides show different cells, and a full expression profiles of individual cells is difficult to obtain. The technique of the present embodiments allows the use of many stains on the same slide and thus provides a useful tool for determining expression profiles of individual cells. This allows detailed cell classification and the characterization of tumor microenvironment.

Other conventional techniques employ flow cytometry in order to determine the expression of differently stained biomarkers. However, unlike the technique of the present embodiments, most flow cytometry systems does not allow connecting the data of multiple biomarkers to the same cell. Some expensive flow cytometry systems do allow measuring of multiple biomarkers on the same cell, however, unlike the technique of the present embodiments, these flow cytometry systems are less suitable for solid tumors because the cells have to be released from the tissue for measurement, losing the spatial information which may be useful for characterizing the tumor and/or cancer.

Other conventional techniques employ mass spectroscopy (e.g., time-of-flight mass spectroscopy, TOF-MS) rather than on optics, whereby a focused beam is scanned point-by-point over the surface of the slide, releasing ions from the surface of the slide and enabling the mass spectroscopy measurement. While these techniques can identify a large number of biomarkers, they are much slower than the technique of the present embodiments because they require point-by-point scanning of the sample. Moreover, unlike the technique of the present embodiments, mass spectroscopy techniques are expensive and complex to operate.

The technique of the present embodiments therefore enjoys both the advantages of optical microscopy from the standpoint of spatial resolution and geometrical context, and the advantages of non-imaging techniques such as flow cytometry and mass spectroscopy from the standpoint of biomarker separation capability.

Following is a more detailed description of system 320, according to some embodiments of the present invention.

System 320 is preferably devoid of any moving parts other than the mechanism that provides for the field-of-view shift.

With reference to FIG. 1, system 320 preferably comprises a mechanical stage 110 configured for shifting the field-of-view of the sample 101 relative to imager 70. FIG. 1 illustrates a preferred embodiment in which imager 70 is static and sample 101 is moveable, but a configuration in which the optical setup of system 320 is placed on stage 110 and the sample 101 is static is also contemplated, and is useful when sample 101 is part of a larger object (e.g., a living body). Typically, the stage 110 is moveable along two lateral axes, XY, parallel to the surface of the sample. Optionally, but not necessarily, stage 110 is also configured to move along the Z axis, perpendicular to the surface of the sample, for example, for the purpose of focusing. In some embodiments of the present invention stage 110 is moveable only along one lateral axis, e.g., the X axis, and in some embodiments of the present invention stage 110 is moveable along one lateral axis, e.g., the X axis, and along the vertical Z axis, but not along the other lateral axis, e.g., the Y axis. The motion of stage 110 can be by means of a motor and gear mechanism (not shown), and is preferably controlled by a controller 200.

The optical setup of system 320 comprises the aforementioned illumination system 10, which optionally and preferably comprises two or more light sources each providing a light beam having a different central wavelength as further detailed hereinabove. Three light sources 10a, 10b, and 10c, are illustrated in FIG. 1, but any number of light sources can be employed according to some embodiments of the present invention. Each of light sources can independently be a light emitting diode (LED) or a laser source, selected to generate light at the desired central wavelength and a sufficiently narrow bandwidth (e.g., less than 30 nm, or less than 20 nm, e.g., 15 nm or less). The central wavelength and bandwidth of each of light sources 10a, 10b and 10c can optionally and preferably be selected by means of a spectrally selective filter, generally shown at 13a, 13b, and 13c, respectively. In some embodiments of the present invention one or more of the light sources of illumination system 10 generates a light beam selected for facilitating imaging in reflectance mode, in either bright or dark field modes.

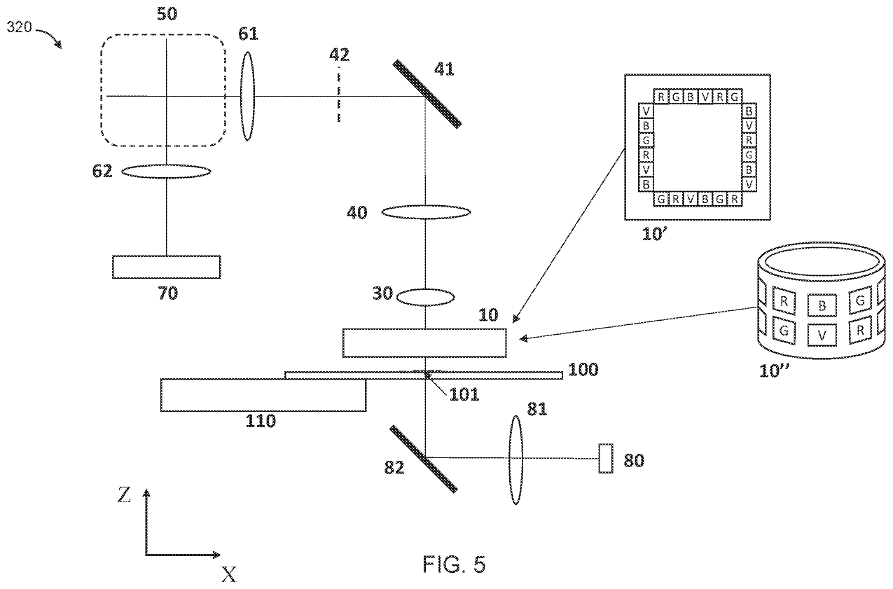

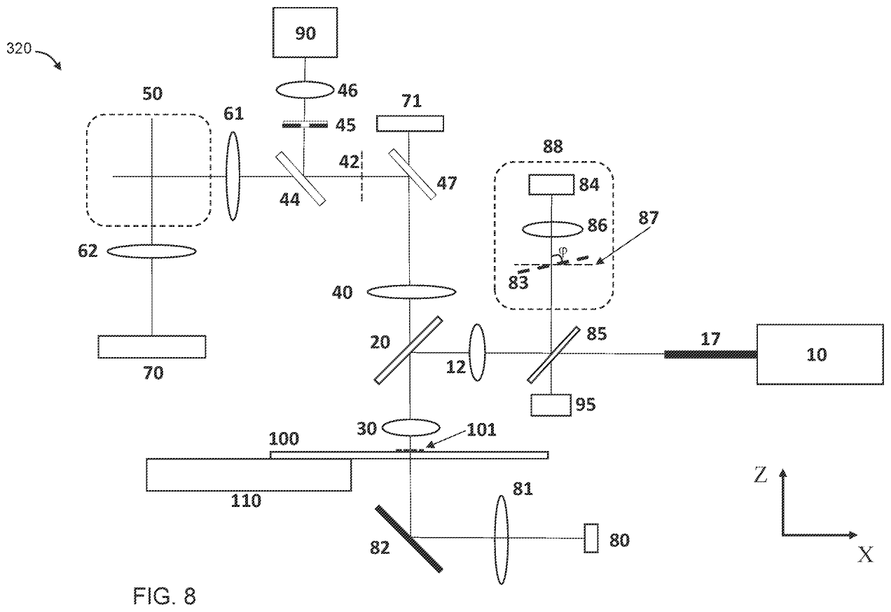

The optical setup of system 320 is preferably arranged such that the light beams from system 10 illuminate sample 101 from its imaged side (the top side in the present example), optionally and preferably through an objective lens 30. In the configuration illustrated in FIG. 1, the light beams from sources 10a, 10b, 10c are redirected to propagate along one optical axis (the-X axis, in the present example), for example, using a light redirecting system 11, which may include an arrangement of dichroic beam splitters 11a, 11b and/or mirrors 11c. However, this need not necessarily be the case, since in some embodiments the light can be directed without the use of light redirecting system 11. For example, system 10 can be a peripheral illumination system as illustrated in FIG. 5, or it can provide illumination by means of a waveguide of an optical fiber 17 as illustrated in FIG. 8.

In some embodiments of the present invention the illumination from light sources 10 is transmitted through a condenser lens 12. The illumination from light sources 10 can be redirected toward sample 101 using a multiband beam splitter 20 which optionally and preferably selectively reflects only narrow wavelength bands around the center wavelengths of the different light beams from system 10, while transmitting light at other wavelengths.

In some embodiments of the present invention system 320 also comprises a bright field light source 80 arranged to illuminate sample 101 from the side that is opposite to the imaged side as further detailed hereinabove. Preferably, the bright field from source 80 is transmitted through a condenser lens 81, and redirected toward the sample 101 (e.g., from below) by a mirror 82.

Illumination system 10 and light source 80 are optionally and preferably also controlled by a controller 200.

In some embodiments of the present invention system 320 also comprises a spectral filter or set of filters 35 for filtering out excitation wavelength that may have been reflected off the sample 101. The transmission curves of filter 35 can be the same or similar to those provided by beam splitter 20, except that the spectral windows of filter 35 are optionally and preferably slightly wider (e.g., 5%, 10%, or 15% wider) than those in beam splitter 20 in order to provide better rejection of the excitation light.

The optical signal output by sample 101 in response to the illumination by any of the light beams, is projected onto imager 70. Imager 70 is optionally and preferably a pixelated imager, such as, but not limited to, a CCD or a CMOS imager. The optical signal is preferably projected onto imager 70 through one or more of: objective lens 30, a tube lens 40 having an image plane 42, and optical system 50. Optionally, a mirror 41 is positioned between tube lens 40 and optical system 50, for example, between tube lens 40 and image plane 42.

Imager 70 optionally and preferably communicates with controller 200 over one or more data channel 72 for allowing controller 200 to receive image data from imager 70. Controller 200 is preferably a computerized controller having image processing capabilities. In some embodiments of the present invention controller 200 communicates with a database 210 storing data locally and/or with a cloud storage facility. The database 210 and/or cloud storage facility can store previously identified cell expression profiles, tissue classification and/or identification and the like.

As stated, optical system 50 has variable optical transmission properties. FIG. 1 illustrates a configuration in which optical system 50 has spatially varying optical transmission properties, in which case the optical signal is collimated before entering optical system 50 by a lens 61 and after exiting optical system 50 by a lens 62. In embodiments in which optical system 50 has temporally varying optical transmission properties, it is optionally and preferably positioned at the image plane 42 of tube lens 40.

FIG. 3 is a schematic illustration of system 320 according to embodiments of the invention in which optical system 50 comprises a Sagnac interferometer. The interferometer 50 is aligned such that the path length difference varies as a function of the entry angle into interferometer 50 in one plane. The interferometer 50 is generally formed of a beam splitter 503 and two mirrors 501, 502, arranged such that the optical signal entering interferometer 50 is split into two secondary optical signals looping within interferometer 50 at opposite direction by reflections off mirrors 501 and 502. Each of the two secondary optical signals completes a Sagnac loop, to interfere with the other secondary signal at the beam splitter 503.

The image of the sample 101, as formed at image plane 42, is projected into interferometer 50 by the entry lens 61 such that each point of the image is projected onto the beam splitter 503 at a different angle, and therefore experiences a different path length difference between the two Sagnac loops, resulting in a different spectral transmission function for different points of the image of sample 101. In the case of a monochromatic light source, this arrangement provides an interference pattern made of lines (also known as fringes) of bright and dark areas, which interference pattern is described by a cosine function.

Upon exiting interferometer 50 each point of the image of sample 101 at image plane 42 is imaged to a different location on imager 70 by the interferometer's exit lens 62, thus providing the image of the sample 101 superimposed by the interference pattern created by interferometer 50. Thus, the spectral transmission factor imposed by interferometer 50 on the signal from any point in sample 101 depends on its location in the field-of-view. This arrangement allows measuring the spectrum of the optical signal from any point of sample 101. A representative procedure for such a measurement includes: (a) scanning sample 101 across the filed-of-view, (b) collecting data generated by each pixel of imager 70 for the respective point of sample 101 as a function of location in the field-of-view (or equivalently as a function of entry angle) to provide a data vector for each pixel, (c) calculating the spectrum of each point of sample 101 by applying an inverse Fourier transform to the data vector, e.g. by means of Fast Fourier Transform (FFT), taking into account the transmission of the interferometer as a function of the entrance angle. The Fourier transformation can optionally and preferably be accompanied by pre- and/or post-processing for apodization, zero filling and spectral smoothing, as known in the art.

Thus, system 320 allows measuring the spectrum from every point of sample 101 for each of the light beams generated by illumination system 10. By collecting the spectra from all points of at least a portion of sample 101 (e.g., part of a slide or a whole slide) a spectral image is created.

When a plurality of light beams having different spectral properties are serially employed in illumination cycles as further detailed hereinabove, by controller 200 control illumination system 10 to activate the individual light beams in synchronization with imager 70. Referring again to FIG. 2, in a preferred embodiment of the invention, the light sources which are exciting fluorescence are operated first, starting with 10a and following with 10b and 10c, and finally also the transmission light source 80 is operated. The illumination cycle is then repeated, such that during every capture of a frame by imager 70, a single light source is activated. Each cycle (going through all the different light sources) is taken at a different field-of-view of the sample 101 relative to imager 70, as schematically shown at frames 201, 202, 203, 204 of FIG. 2.

The movement of stage 110 can be continuous, such that in each frame the object is at a different location and even during exposure the object is moving (contributing to an acceptable level of smearing in the image), or by steps. The latter options (stepping stage 110 from one position to the other) is preferred because in this case the data generated for each light beam within the illumination cycle corresponds to the same field-of-view. The steps at which stage 110 is advanced are preferably smaller than the fringe width for the shortest wavelength, according to the Nyquist minimum sampling law. The inventor found that by employing such a criterion activation of imager 70 during motion does not significantly deteriorate the quality of the spectra. In some embodiments of the present invention a calibration procedure is employed for calibrating one or more of the following parameters: the angle between direction of motion of stage 110 and one of the axes of the grid of imager 70, the ratio between the motion of stage 110 and the location of the image, and the speed of stage 110.

At the end of all the illumination cycles and corresponding image acquisitions, the collected image data thus includes a plurality of data vectors, each corresponding to one pixel of imager 70, wherein each data vector includes a plurality of values that take into account both the shifts in the field-of-view and the switching between the spectral characteristics of the illumination. Ideally, each data vector can include N·M data values where N and M are, as stated the number of illuminations per cycle (the number of light sources or combinations of light sources) and the number of cycles, respectively. However, data vectors shorter than N·M are found to be adequate as well. It is appreciated that instead of generating data vector that include N·M data values, one can alternatively generate, for each pixel, N data vectors of length M, thus allowing generating N spectral images, one spectral image for light source or combinations of light sources.

The advantage of system 320 is that sample 101 can be scanned over the field-of-view only once, while image data are collected in parallel for multiple different light sources. For example, image data can be collected in parallel for multiple excitation sources 10a, 10b, 10c, giving rise to fluorescence as well as for transmission signal from bright field source 80. One or more of the light sources of illumination system 10 can generate light beams selected for facilitating imaging in reflectance mode, in either bright or dark field modes.

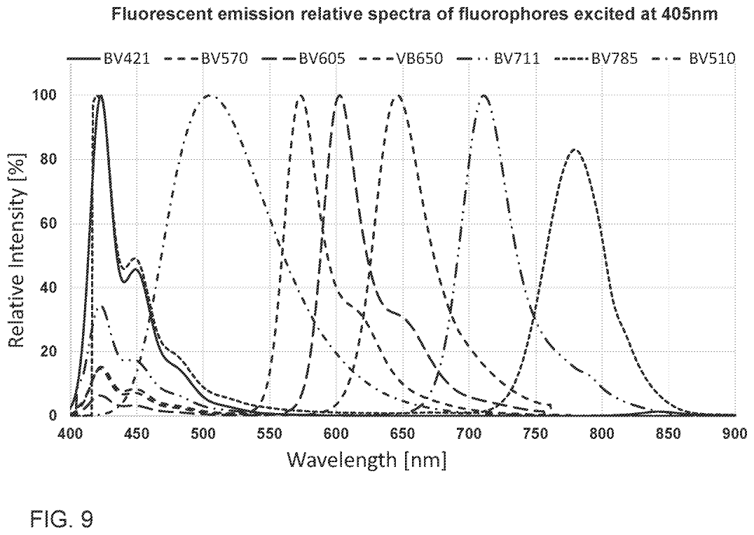

When a single monochromatic light source is used by system 320, a sample stained with multiple fluorophores in conjunction with different biomarkers (e.g., antibodies), can be imaged and analyzed to provide a density of multiple biomarkers simultaneously. For example, a typical set of fluorophores having excitation wavelength of about 405 nm is based on the Brilliant Violet set of fluorophores. A representative example showing the emission spectra of BV421, BV480, BV510, BV605, BV650, BV711, BV750 and BV786 is shown in FIG. 9. As shown, the differences between the emission spectra of all fluorophores is sufficiently large to enable unmixing. Since system 320 facilitates use of several distinct excitation wavelengths (each provided by one or more of the light sources of system 10), a sample stained with multiple fluorophores each excitable by different wavelengths can be imaged, thus allowing to separate multiple number of fluorophore (at least 6 or at least 8 or at least 12 or at least 16) at the same scan, on the same slide. For example, system 320 can employ light sources providing at least two or at least three or each of the central wavelengths selected from the group consisting of about 405 nm, about 488 nm, about 532 nm and about 640 nm.

Data collection can be performed either in a continuous scanning mode or in a step-and-measure mode. In the continuous scanning mode, sample 101 is continuously moving, hence the images obtained when different light sources are activated are different. However it was found that this does not limit the performance of the system because data for each point in sample 101 is collected multiple times (by virtue of the field-of-view overlaps among different frames). In a continuous scanning mode, the time periods within each cycle are optionally and preferably sufficiently short to minimize smearing. For example, the time periods within each cycle can be less than the time it takes stage 110 to cover a distance equal to the pixel size on the sample plane. As a numerical example, consider a case in which stage 110 moves at a speed of 1 mm/sec and the pixel size is 1 micron. In this case the time periods within each illumination cycle is about 1 ms. The time periods within each illumination cycle can alternatively be less than any multiplier of the above time duration, e.g., 0.5, 0.25, 2, 4 times the time duration. This mode is therefore more preferred from the standpoint of measurement speed and is less preferred from the standpoint of spatial and spectral resolution.

In the step-and-measure operation mode, stage 110 septs between locations after every illumination cycle and stays static until all images have been taken using the different light sources. This mode allows for longer exposures and possibly even using illumination pulses longer than the single frame time, and is therefore more preferred from the standpoint of spatial and spectral resolution and is less preferred from the standpoint of measurement speed.

When optical system 50 varies its transmission properties as a function of the time, it can be embodied as rotating filter set, a voltage-controlled liquid crystal element, or any other technology which allows filter properties to be switched in a temporal manner. According to this scanning method a full set of spectral transmission properties is employed at each field-of-view. The obtained images can then be used to calculate a data vector for each point in the field-of-view. Moreover, in addition to taking the full set of images under one illumination condition, the whole process is optionally and preferably repeated in cycles with different illumination conditions. The switching between the spectral transmission properties and the switching between the light sources can be done in either order. For example, in case in which switching between the spectral transmission properties of optical system 50 is slower than the switching between the light sources, system 320 can collect images using all the different light sources for the first the spectral transmission property of optical system 50, e.g., in consecutive frames, then change the spectral transmission property of optical system 50 and collect images using each of the different light sources again, and so on, until all the spectral transmission properties of optical system 50 have been used. Conversely, in case in which switching between the spectral transmission properties of optical system 50 is faster than the switching between the light sources, system 320 can collect data for all possible spectral transmission properties of optical system 50 using one light source, then collect data for all possible spectral transmission properties of optical system 50 using another light source and so on.

Once the full data, for all spectral transmission properties of optical system 50 and all light sources, has been collected in one field of view system 320 shifts the field-of-view and repeats the process for the new field-of-view until the full sample is scanned.

The inventor found that a sufficiently accurate spectrum can be obtained when the data vector has a few tens of data values. Therefore, the shift of the field-of-view between successive image frames taken with the same light source (e.g., frames Δt₁ and Δt₅, in the non-limiting example illustrated in FIG. 2) can be at the amount of several pixels without compromising the spatial and the spectral resolution. For example, if the system's spectral range is from about 400 nm to about 800 nm and the required spectral resolution is about 10 nm, then it is sufficient to have about 40 data values for the data vector, or about 80 data values if the data vector is symmetric. Thus, for an imager having about 960 pixels across the field-of-view, the shift in field-of-view between successive image frames taken with the same illumination source image can be at the amount of about 12 pixels.

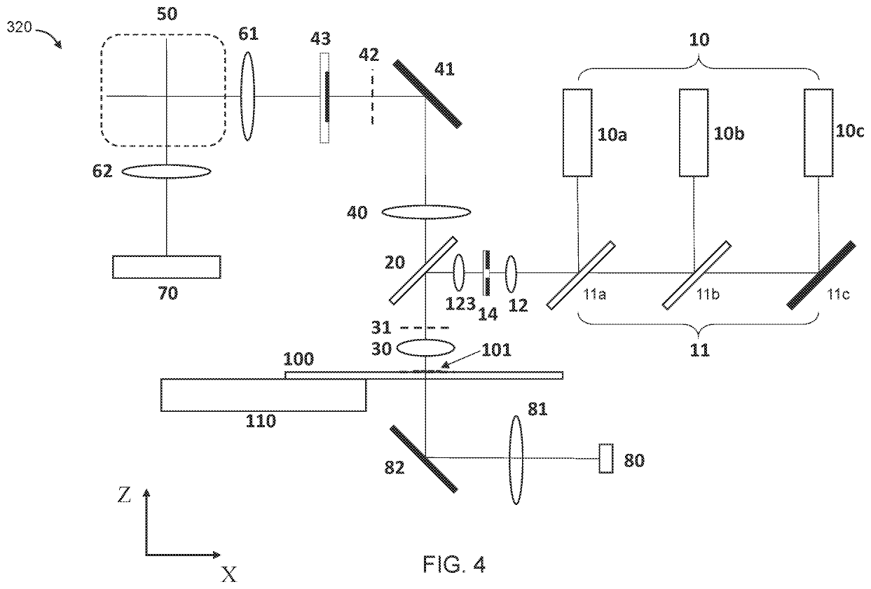

FIG. 4 is a schematic illustration of system 320, according to embodiments of the invention in which a pinhole is employed for reducing a solid angle of light beams illuminating the sample. The advantage of these embodiments is that they allow reducing the contribution of excitation light to the acquired image data. As shown in FIG. 4, a pinhole 14 is inserted in the illumination path after the condenser lens 12, typically close to the focal plane of condenser lens 12. The pinhole 14 is imaged by a lens 123 onto the back focal plane 31 of objective 30 thus reducing the solid angle of the illumination.

The signal from sample 101 has three main components, including the fluorescence from the sample, which is typically Lambertian and has a wide solid angle, a reflection from the sample which has the same solid angle as the illumination, and scattering from the sample which is decreasing with increasing angle from the normal to the sample's plane. In order to further reject the two latter components which create an unwanted background in the image data, an additional beam stop 43 is placed in the return path. Preferably, beam stop 43 is positioned at the image plane of the objective's back focal plane 31 through the tube lens 40. Thus, light beams leaving sample 101 at near normal angles are confined in the plane of 43 to a disc close to the optical axis and are blocked by beam stop 43. The diameter of beam stop 43 is optionally and preferably selected such that it blocks more than the solid angle of the illumination, e.g., equivalent to 2 times the angle of the illumination cone, or alternatively half of the total diameter of the aperture of the system at the plane of beam stop 43, thus removing a significant portion of the reflected signal and the scattered signal, and only a small portion of the fluorescent signal.

FIG. 5 is a schematic illustration of system 320 according to embodiments of the invention in which system 10 is a peripheral illumination system. In this embodiment an array of light sources, e.g., an array of LEDs, is arranged such that they illuminate sample 101 outside of the aperture of objective lens 30. For example, as illustrated in FIG. 5 the light sources can be arranged peripherally with respect to the optical axis of objective lens 30, with or without focusing optics. Several similar light sources, operated together, e.g., LEDs with same emission spectrum, may be located at several peripheral locations of the arrangement in order to improve illumination uniformity. The arrangement of light source can be generally planar, e.g., as shown at 10′, or it can form a nonplanar shape as shown at 10″. In FIG. 5, R, G, B and V indicate different LED types illuminating at different center wavelengths. Other illumination methods, such a sinusoidal illumination, a dark field mode, a total internal reflection mode, a highly-inclined beam, or HiLo illumination, can also be employed by system 320.

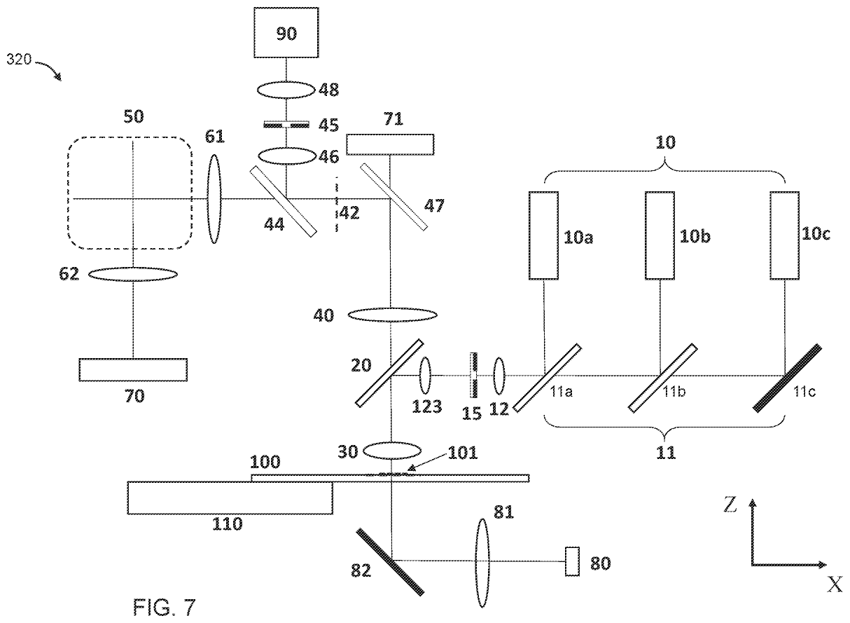

FIG. 7 is a schematic illustration of system 320 according to embodiments of the invention in which the system also comprises a spectrometer 90 and/or an additional imager 71, which may optionally and preferably be used as a review and calibration channel. In the illustrated embodiment, a light beam from illumination system 10 is imaged by lens 12 onto an illumination pinhole 15 which is then imaged by lens 123 and objective lens 30 onto the surface of sample 101, to illuminate a specific part of sample 101. Note that pinhole 15 has a different function than pinhole 14 (not shown in FIG. 7, see FIG. 4). While pinhole 15 is imaged onto sample 101, pinhole 14 is imaged onto the back focal plane 31 of objective 30. Preferably, pinhole 15 is introduced into system 320 before executing a calibration protocol using spectrometer 90 and is removed from system 320 before the acquisition of image data to produce the spectral image.

A portion of the optical signal that is responsive to the illumination (e.g., fluorescence, transmission, reflectance) is redirected by a beam splitter 44 to a collection pinhole 45, which is optionally and preferably positioned at the image plane of a lens 46, and which spatially narrows the optical signal. Typically, the image of the collection pinhole 45 on the surface of sample 101 is smaller than the image of the illumination pinhole 15, thus providing a smaller area which is actually sampled. For example, the size of the image of the collection pinhole 45 on the surface of sample 101 can be the size of a single cell or a nucleus or smaller. The optical signal passes through pinhole 45 and is then imaged by a lens 48 onto the entrance of spectrometer 90, which is preferably a non-imaging spectrometer. Alternatively, spectrometer 90 can include an optical fiber entrance in which case the end of the fiber (not shown) can serve as the pinhole 45 or be attached immediately after pinhole 45. Note that the optical channel that includes spectrometer 90 typically has a spatial resolution that is less than the spatial resolution of imager 70 and so the spectrum obtained by spectrometer 90 corresponds to an average over a plurality of pixels of imager 70.

The advantage of having spectrometer 90 in system 320 is that it can be used for assessing the accuracy of the spectral image generated by system 320, by providing a figure of merit for the difference and the similarity between measurements obtained by the spectrometer 90 and measurements obtained by imager 70 by means of optical system 50. The assessment can be used for constructing a correction function that receives as input a spectrum measured by imager 70 and optical system 50, and returns a corrected spectrum that is closer to the spectrum that would have been measured at the same location using spectrometer 90. The correction function can also be used to correct other data measured by system 320. A representative example of a calibration protocol suitable for the present embodiments is provided in the Examples section that follows (see Example 2).

System 320 can optionally and preferably include an additional imaging channel utilizing additional imager 71. Imager 71 can be positioned at the image plane of tube lens 40. In this configuration the mirror 41 (sec, e.g., FIG. 1) is replaced with a beam splitter 47 located before the image plane of the tube lens 40, so as to redirect a portion of the optical signal also to imager 71. This additional imaging channel can be used in order to obtain a non-spectral image of sample 101 (e.g., an RGB image having 3 intensity values per pixel, or a grey-level image having a single intensity value per pixel). Preferably, imager 71 is utilized in conjugation with bright field source 80, e.g., in transmission mode. This is particularly useful when sample 101 is stained with a stain that is imageable in transmission mode (e.g., H&E and the like).

FIG. 8 is a schematic illustration of system 320 according to embodiments of the invention in which system 320 employs a pattern that is projected onto the sample. In the illustrated embodiment a projector system 88 is used in order to measure and correct the focusing of the image created on the imager 70 and/or 71. Projector system 88 comprises an additional light source 84, a lens 86, a patterned element 83 and beam splitter 85. System 88 can be placed such that the image plane 87 of the lens 86, coincides with the image plane of lens 12 after redirection by beam splitter 85, so that an object placed in the image plane 87 creates a sharp shadow on the sample plane. Patterned element 83 can include, e.g., a coarse linear grid made of alternating lines of transmissive and non-transmissive materials such as, but not limited to, a chrome mask on a glass substrate, covering at a line width and frequency such that once the pattern of patterned element 83 is projected onto sample 101 it can be imaged by imager 71. For example, patterned element 83 can include from about 10 to about 100 lines across the field-of-view of the imager. Patterned element 83 is placed at image plane 87 at an oblique angle φ to the optical axis of lens 86. Typical values for φ are from about 80° to about 100°, excluding 90°. The oblique angle ensures that only a small part of patterned element 83 that is at or close to the image plane 87 is focused to the sample plane while other parts of the pattern are increasingly defocused.

Since the sample 101 typically does not have a uniform thickness, the tilt of patterned element 83 ensures that at any given height of the sample there is a part of the projected pattern that is in focus. The location of that part in the image provides information pertaining to both the amount and the direction of the correction that can improve the focus.

In use, imager 71 images the projection of the pattern of element 83 on sample 101. The image is analyzed to determine the defocus parameters of different parts of the projected pattern. For example, the analysis can include averaging the intensity along the direction of the grid lines in order to obtain a vector of intensities across the lines, thus improving signal to noise and removing the effect of the underlying pattern. The analysis can also include assigning a defocus parameter to each line or group of lines on the image of the projected grid, and identifying the region in the image at which the best focus is obtained. The distance between the region at which the best focus is achieved and the nominal best focus region can be a direct measure of the defocus and controller 200 can operate to minimize this difference, for example, by moving the stage 110 along the Z axis. This is optionally and preferably performed continuously or repeatedly during the operation of system 320. In order to reduce the disturbance to the acquisition of the image data for the spectral image, the focusing channel is optionally and preferably operated in part of the spectrum beyond the measurement spectral range, e.g. in the infrared. Focusing measurements can be taken during the motion of stage 110, or between measurement stops.

While the Sagnac interferometer shown in FIG. 3 can provide adequate results, the Inventor found that conventional Sagnac interferometer can be improved. The three main optical elements of conventional Sagnac interferometer (two mirrors 501 and 502 and beam splitter 503) are typically implemented as three free-standing optical elements. The inventor found that this arrangement may be sensitive to misalignment of these optical elements with respect to each other, in particular due to changes in the environmental temperature and during transport. The Inventor has therefore devised a monolithic Sagnac interferometer that is more stable and robust to vibrations, shocks and temperature variations, compared to conventional interferometers.

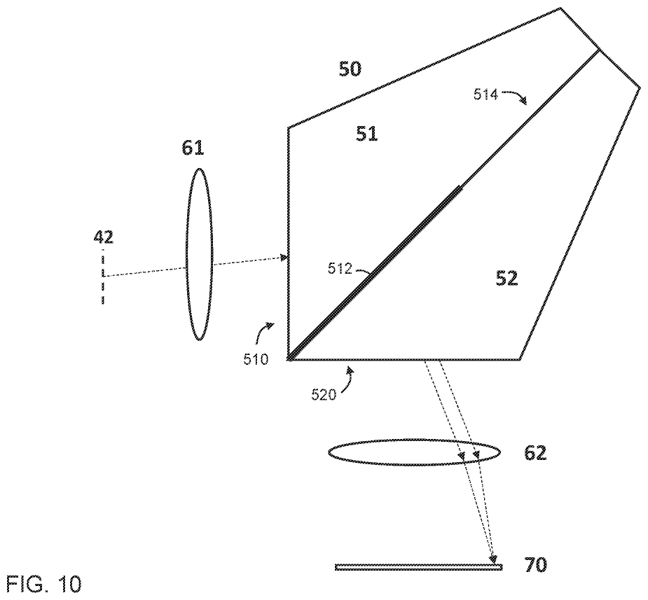

FIGS. 10-13, 15A-B and 17 are schematic illustrations of optical system 50 in embodiments of the present invention in which system 50 comprises a monolithic Sagnac interferometer. In the illustrated embodiments, optical system 50 comprises two attached prisms 51, 52 forming together an asymmetric monolithic structure having an entry facet 510 at prism 51 and an exit facet 520 at prism 52. Optical system 50 also comprises a beam splitter 512 engaging a portion of an attachment area 514 between prisms 51 and 52. Typically, the optical signal (e.g., as imaged at image plane 42) is collimating by lens 61 and enters into the monolithic structure through entry facet 510. The optical signal is split within the monolithic structure into two secondary optical signals that perform a Sangnac loop and exit through exit facet 520. The secondary optical signals are then focused by lens 62 and defected by imager 70.

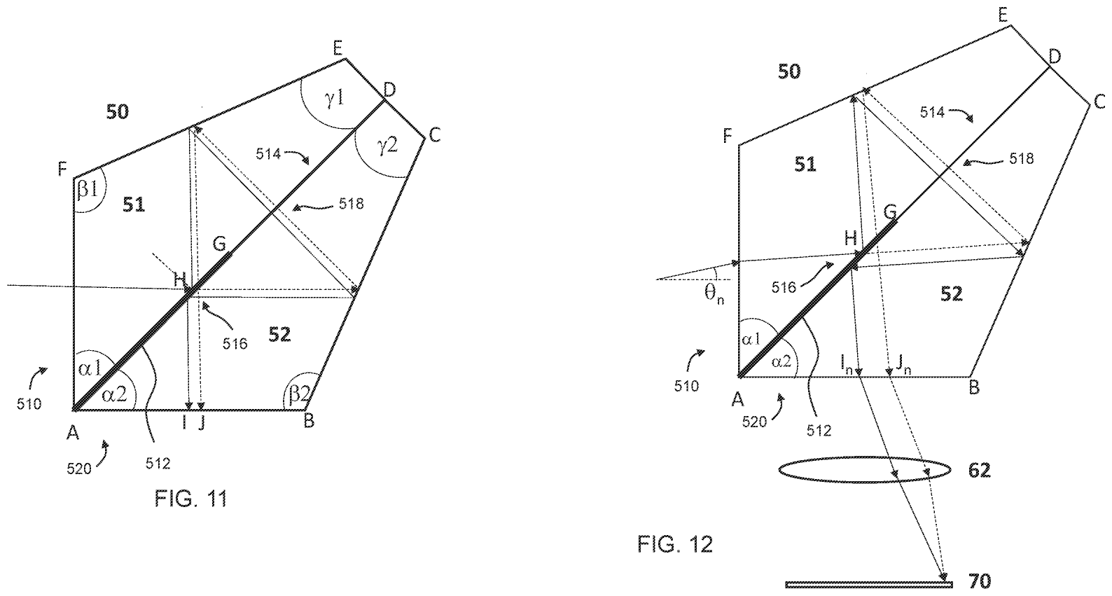

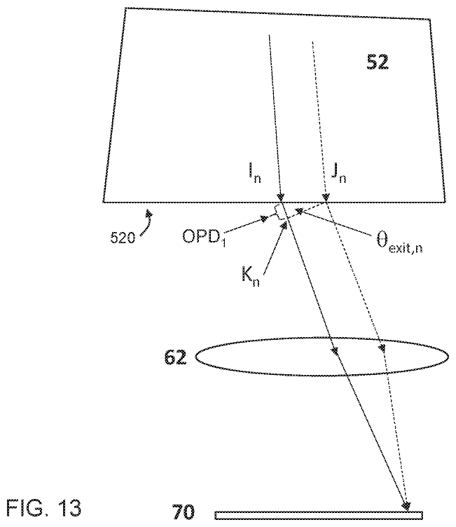

Beam splitter 512 is configured for splitting the optical signal that enters through entry facet 510 into two secondary optical signals exiting through exit facet 520. With reference to FIGS. 11 and 12. The two secondary optical signals perform a Sagnac loop within the monolithic structure and exit through spaced apart points I and J at facet 520. The size of beam splitter 512 is preferably selected to ensure that the optical paths of the secondary optical signals impinge on the attachment area 514 both at locations 516 engaged by beam splitter 512 and at locations 518 not engaged by beam splitter 520.

The asymmetry of the monolithic structure can be ensured in more than one way. In some embodiments of the present invention, illustrated in FIGS. 10-13, the two prisms have different shapes. For example, the angles α1, α2 between the attachment area 514 and the facets 510 and 520, respectively, can differ. Denoting the absolute value of the difference between α1 and α2 by 2dθ, so that dθ=α1−α2|/2, the inventor found that an acceptable OPD range can be obtained by selecting the value of de within the range of difference 1 arcminute ≤dθ≤20 arcminutes. Alternatively or additionally, the angles β1, β2 that are opposite to the attachment area 514 and that are defined between to adjacent facets in prisms 51 and 52, respectively, can differ.

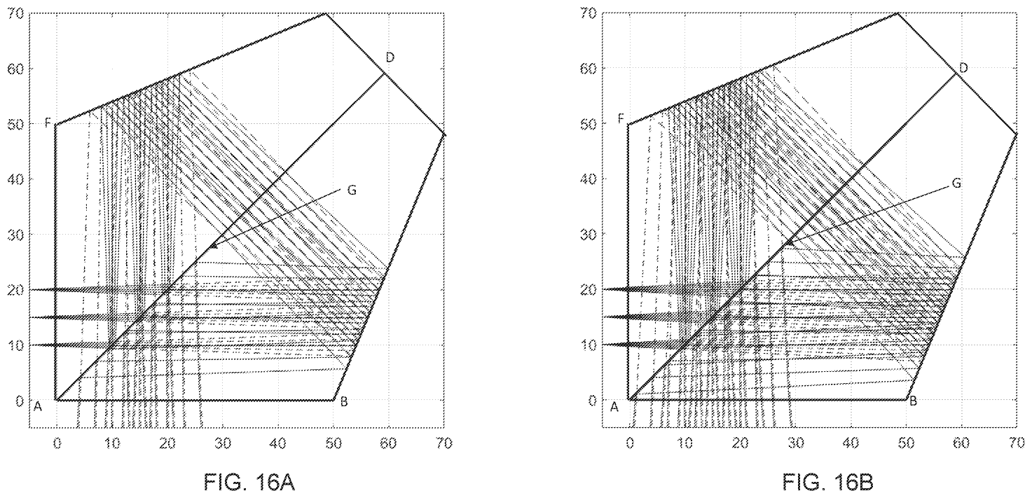

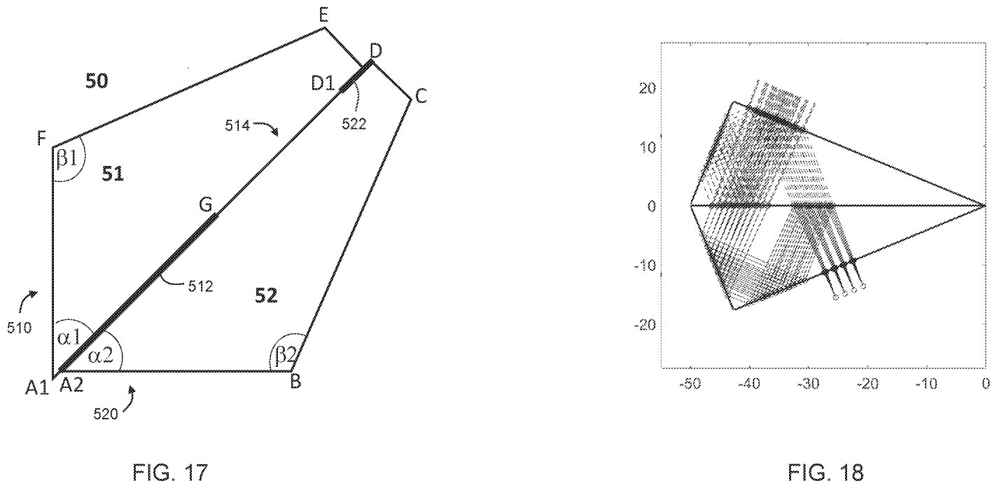

In another embodiment, illustrated in FIGS. 15A-B and 17, prisms 51 and 52 are identical but are attached in an offset relation to one another, wherein the vertex A1 that is formed between the entry facet 510 and the facet of prism 51 that is attached to prism 52 is offset relative to the vertex A2 that is formed between the exit facet 520 and the facet of prism 52 that is attached to prism 51. The amount of offset (the distance between A1 and A2, in FIG. 17) is preferably a few hundreds of micrometers (e.g., from about 200 μm to about 500 μm, e.g., about 400 μm).

In any of the embodiments herein, the sum of the angles of the individual prisms 51 and 52 at the attachment facet (α1+α2 in FIGS. 10-13, 15A-B and 17) is optionally about 90°.

In some embodiments of the present invention the monolithic structure comprises a spacer 522 (FIG. 17) at attachment area 514, wherein spacer 522 is spaced apart from beam splitter 512 away from any of the optical paths of the secondary optical signals within the monolithic structure. The advantage of these embodiments is that they allow an easy alignment of the attached facets of prisms 51 and 52 to be parallel to each other. In a preferred embodiment, spacer 522 is made of the same material and thickness as beam splitter 512, thus ensuring that the distance between the attached facets of prisms 51 and 52 is the same in the region of beam splitter 512 as in the region of spacer 522.

With specific reference now to FIG. 11, the two prisms 51 and 52 are attached on the facet designated by AD. The attachment can be by an optical glue which is transparent in the intended spectral range of the system and an index of refraction similar to that of the prisms. The shapes of prisms 51 and 52 are preferably selected such that the angle between the direction of the optical signal that enters through facet 510 and the direction of the optical signals that exit through facet 520 is about 90°. The monolithic structure can in some embodiments have a shape of a penta-prism.

The prisms 51 and 52 can be made of identical optical material, e.g., glass, quartz, or other materials transmitting in the visible range, or alternatively IR-transmitting or UV-transmitting materials. Preferably, the entry facet 510, and the exit facet 520 are coated by anti-reflective coating. Preferably, reflective coatings are applied to the facet from which the secondary optical signals are internally reflected (facets EF and CB, in the present example). Beam splitter 512 can be embodied as a coating on a portion of the attachment facet of one of prisms 51 and 52. The portion of the attachment facet which is coated by the beam splitter material is designated AG.

The configuration in which the beam splitter 512 engages only a portion of the attachment area 514 allows the secondary optical signals to pass freely between the prisms 51 and 52 after reflecting off the reflective facets mirrors FE and BC. The optimal location of G is preferably selected based on the width of the optical signal at the entry facet 510 and its angular spread. Typical values for the length AG are from about 55% to about 115% of the length of facet 510, more preferably from about 70% to about 100% of the length of facet 510. Further details regarding the optimization of the size of the beam splitter 512 is provided in the Examples section that follows (see Example 4).

Typical values for the angles α1 and α2 are about 45°, typical values for the angles β1 and β2 are about 112.5°, and typical values for the angles γ1 and γ2 are about 22.5°.

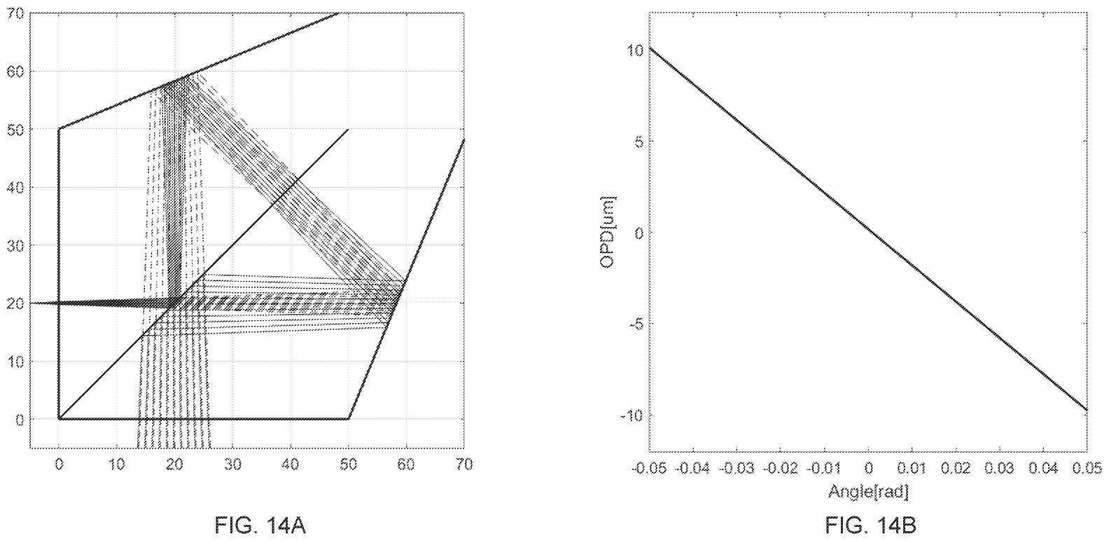

The operation principle of the monolithic structure of the present embodiments can be better understood with reference to FIGS. 12 and 13. Shown in FIG. 12 is a representative ray of the optical signal that enters through facet 510 and impinges on beam splitter 512 at point H. The ray is split into two secondary rays there propagate along a clockwise path and a counter-clockwise path, as will now be explained. The clockwise path begins by a reflection off beam splitter 512 within prism 51, reflection off the reflective facet FE, propagation through region 518 into prism 52, reflection off reflective facet BC, and reflection off beam splitter 512 within prism 52 toward point Iₙ of exit facet 520. The clockwise path is also referred to herein as a reflective path, because the secondary ray is reflected twice by beam splitter 512. The counter-clockwise path begins by transmission through beam splitter 512 from prism 51 to prism 52, reflection off the reflective facet BC, propagation through region 518 into prism 51, reflection off reflective facet FE, and transmission through beam splitter 512 from prism 51 to prism 52 toward point Jₙ of exit facet 520. The counter-clockwise path is also referred to herein as a transmission path, because the secondary ray is transmitted twice by beam splitter 512.

The paths depend on the entry angle θₙ to the entry facet 510, and so are the exit points Iₙ, Jₙ at the exit facet 520. The Inventors found by computer simulations that for a wide range of conditions, both rays exit facet 520 parallel to each other, but with varying distances dX=Jₙ−Iₙ. The Inventors found that dX depends on the shape of the prisms (e.g. the values of the angles α1, α2, β1, β2) but does not depend on the entry angle θ.

The two rays that exit prism 52 are focused by lens 62 onto imager 70. Since they are parallel to each other, they arrive at the same pixel of imager 70 and so the interference occurs at the imager and not within the interferometer.

With reference to FIG. 13, the relative phase between the rays depends on the optical path difference (OPD) accumulated from the time they split at point H until the time they interfere on the imager 70. There are two contributions to the OPD: a first contribution is the difference of the accumulated length from point H until each of the rays reaches points Iₙ and Jₙ on facet 520, and a second contribution is the difference in accumulated length between facet 520 and a location at which the two secondary rays reach the same wave front, perpendicular to the ray direction of propagation. The second contribution is shown in FIG. 13, where the projection of exit point Jₙ. on the ray exiting through Iₙ is denoted by Kₙ, and the segment Kn-In is denoted as OPD₁. According to basic lens optics, the rest of the path to the imager is identical. The Inventor found by computer simulations that the main contribution to the OPD is the short segment OPD1, since the accumulated lengths from H to Iₙ and Jₙ are similar. Therefore, the OPD is approximately OPD1=dX*sin(θ_{exit,n})≈dX*θ_{exit,n}. The Inventor found that under a wide range of conditions the direction θ_{exit,n} of the exit ray is equal or approximately equal to the entry angle θₙ, and so OPD≈dX*θₙ. Since dX does not typically depend on θₙ, there is a linear dependence between the optical path difference OPD and the sine of the entry angle, and for sufficiently small values of θₙ, there is linear dependence between the optical path difference OPD and the entry angle.

The Inventor found for typical conditions wherein the prisms are made of the same materials and the size of the entry facet is of the order of 50 mm, non-linear contributions to the OPD are much smaller than the wavelength of visible light and therefore do not affect the interference pattern. Thus, under conditions of generally uniform illumination within a relevant range of angles uniformly-spaced interference fringes are formed on the surface of imager 70.

The monolithic structure of the present embodiments enjoys many advantages over the Michelson-type interferometer described in U.S. Pat. No. 11,300,799 B2 supra. A first advantage is that in the Michelson-type interferometer patent there is a high sensitivity to the shift between the two prisms. This results in fabrication difficulties because adequate performance requires fabrication accuracy of a few micrometers. Another difficulty in the Michelson-type interferometer is that the shift has to fit the difference in size between the two prisms, and so must also compensate for the tolerance in the size differences between the prisms. As a result, manufacturing of the Michelson-type interferometer must include assembly of the prisms under the inspection of the resulting fringes and has to be accurate within a few microns. The monolithic structure of the present embodiments allows a shift of several tens of micrometer, a tolerance that can be achieved using standard assembly jigs and does not require assembly under inspection.

Furthermore, the optical path within the Michelson-type interferometer of the ′799 patent are complex, including five reflective surfaces. The optical path within the monolithic structure of the present embodiments includes only three reflective surfaces, making it much less sensitive to angular tolerances of the reflective facets. The Michelson-type interferometer is thus much prone for aberrations that increase with the number of reflections.

Another advantage is that in the monolithic structure of the present embodiments includes the entry and exit rays are generally perpendicular to each other. This is advantageous over the Michelson-type interferometer in which there is a tilt of about 45° between the entry and exit angles, making the device less compact in the overall optical setup.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment.

Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### Example 1

### Representative Protocol

Following is an exemplified protocol that can be executed using system 320.
(a) Stain the slide with multiple immunohistochemical stains, each stain comprising an antibody specific to a certain protein or alternatively (e.g., FISH) binding to specific DNA or RNA sequences or to a different biological tissue section. Note that the fluorescent reporters connected to different antibodies should be sufficiently well separable by nature of their different spectral characteristics to allow spectral unmixing, as done e.g., in flow cytometry. Optionally, additionally stain with absorption stains on the same slide, e.g., Hematoxylin, Eosin, and others.
(b) Scan the sample using system 320 to obtain a spectral image of the sample for each light source.
(c) Calculate a series of spectra for each point of the image, each spectrum corresponds to the illumination with one (or a combination) of the light sources.
(d) Optional local filtering, removing noise in either lateral (XY) and or spectral dimensions using local filtering such as e.g., averaging over a fixed window, convolution with a smoothing function, median or nearest neighbors, etc.
(e) Spectral analysis of the spectra measured at each point in the object, finding the density of each of the used biomarkers. This analysis can make use of spectral unmixing algorithms as well as cross-referencing between different measurements, using different excitation light source and using image analysis algorithms.

The output of this protocol can provide a density map for each biomarker across the full area of the sample.

### Example 2

### Representative Calibration Protocol

Following is an exemplified protocol that can be executed using system 320, in embodiments in which system 320 includes a spectrometer.
(a) Optionally, place a calibration sample on substrate 100.
(b) Scan the sample to obtain a spectral image using system 320 as further detailed hereinabove.
(c) Identify (manually or automatically) point of interest for review.
(d) Move stage 110 such that the first point of interest is in the field of view, in a position compatible with the center of the collection area, as defined by the image of the collection pinhole 45 in the sample space
(e) Collect a spectrum (or several spectra, using different light sources) using the spectrometer 90
(f) Move stage 110 to the next point of interest and repeat (d) and (e) until all points of interest have been measured.
(g) Compare the similarity between the spectra obtained using the scanning mode to the spectra collected by the spectrometer at (d)-(f), and provide figures of merit for the difference and the similarity, so as to assess the accuracy of the spectral measurement.
(h) Optionally, construct a correction function that receives as input a spectrum measured by system 320 during scanning and returns a corrected spectrum that is closer, according to a selected merit function, to the spectrum that would have been measured at the same location using the spectrometer.
(i) Optionally, utilize the correction function constructed at (h) for all the data measured by system 320 during scanning prior to additional analysis.

### Example 3

### Representative Sample Analysis Protocol

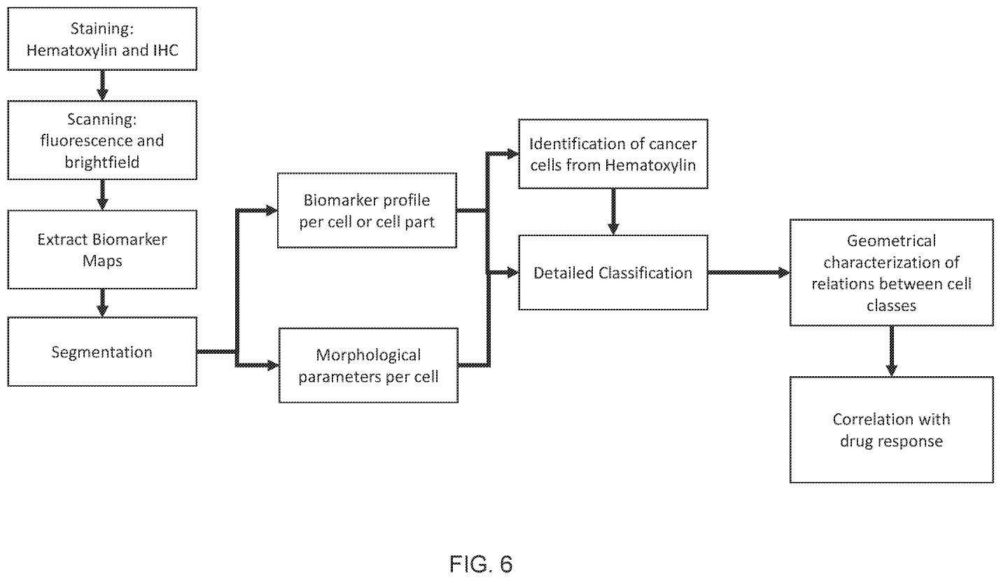

FIG. 6 is a flowchart diagram illustrating an exemplified sample analysis protocol according to some embodiments of the present invention.

The flow optionally and preferably begins with the staining and scanning as further detailed hereinabove, resulting in a spectral image for each light source. Note that data collection can be done in several scanning iterations, for example, several biomarkers can be used in the first iterations, each biomarker color-coded with a different (fluorescent) reporter, followed by a washing operation which removes part or all of the (fluorescent) reporters. A new set of biomarkers can then be activated, e.g., using a second staining operation or by attaching the same or different reporters to other antibodies already attached to the sample. A second iteration of scanning can then be performed, so as to map additional biomarker on the same sample. Another example of an iterative process includes at least one operation in which fluorescent reporters are applied and measured and a different operation in which absorption stains (e.g., Hematoxylin & Eosin, H&E) are applied to the sample and measured in bright field (BF) mode. In case the BF measurement is done after fluorescent biomarker have been applied to the sample, measuring the sample in BF before H&E staining may provide a background image which can be later removed from the image after staining in order to eliminate crosstalk between the two measurement modes. Measuring the H&E-stained sample in fluorescent mode before fluorescent staining may provide a reference image that may reduce cross talk from the earlier stains (e.g., absorption stains) or from auto-fluorescence caused by fluorescent molecules in the unstained tissue to the later stains (e.g., fluorescent stains).

Following data collection, the analysis continues by extraction of the density maps of each biomarker from the spectral images using spectral unmixing methods, e.g., single value decomposition (SVD). Alternatively, following scanning, the data vector from each point of the sample can be directly analyzed. In this case, the data vector is not translated to the spectral domain. Instead, the system includes a set of expected data vectors (e.g., interferograms), which correspond to the different stains applied to the sample, and the extraction of the density of each biomarker is done in the data vector space, by fitting the raw data vector measured at each point as a combination of the expected data vectors. Extracting the contribution of each expected raw data vector to the measured vector at any given point can also be done using other methods, e.g., by use of a machine learning, such as, but not limited to, neural network.

Next, the images are optionally and preferably segmented to individual cells or cell parts such as nucleus, cytoplasm, membrane, using classical segmentation techniques or machine learning. The biomarker values are than averaged over each segment, creating a biomarker profile for each cell or part of a cell. An additional optional output from the segmentation process is a set of morphological characteristics of each cell. As the input to the segmentation stage may optionally include multiple density maps, there is much information that can be extracted at this stage as morphology may be more pronounce in density maps of some biomarkers than others. Thus, morphological parameters may include, for example, the nonuniformity per each biomarker and additional parameters identifying the texture as observed independently at any density map.

One of the biomarkers analyzed from the brightfield images can optionally and preferably be Hematoxylin, which allows making a preliminary classification between cancer cells and normal cells. The ability to identify individual cancer cells automatically rather than using labor-intensive manual tagging, allows the system of the present embodiments to perform effective unsupervised machine learning, making the process of classification and additional analysis tasks much quicker and effective.

More advanced classification can be made based on the enhanced biomarker profiles (optionally including morphological parameters) by either identifying groups of cells that have similar profiles or by comparing profiles in the sample to known profiles in a database. Identified groups of cells having similar biomarker profiles but which do not correlate to any of the known cell classes in the database can be prompted to the user for identification and their common properties can later be saved for later reference in the database. Cloud storage of biomarker profile classes found in other cases and their potential identification can also be employed to allow sharing of knowledge between medical sites without compromising patient privacy. Cell classification may be visually displayed to the user, e.g., overlaid on top of a reconstructed H&E image which can be created from the densities of these two biomarkers. Cell classes may optionally and preferably be shown using false coloring of the area of the cells, assigning each class of cells a unique set of fill color and perimeter (membrane) color.

Once cell classes have been identified, the interplay between different class of cell may be measured. For example, larger areas, having a higher density of identified cancer cells may be identified as tumor tissue, while other large areas may be identified as normal tissue. The relative density of different cell types can then be compared between tumor tissue and normal tissue. The average distance between different types of cells or the correlation in their low-resolution density maps can also be measured, identifying cell types that tend to be found together, e.g., cancer cell and immune system cells.

A dataset including the above characteristics of the sample can be created, and be defined as a fingerprint of the tumor, summarizing in general terms the characteristics of the tumor and the interplay between different cell types in the tumor.

Optionally, the protocol searches for correlation between fingerprint parameters of the tumor and the response of different patients to a given therapy. Retrospective or prospective clinical studies can provide data that allows identifying tumor fingerprint features, based on which the likelihood that a certain therapy will be successful can be predicted. Prediction can optionally and preferably be based on Artificial Intelligence techniques such as, but not limited to, machine learning.

### Example 4

### Computer Simulations

Following is a description of computer simulations performed according to some embodiments of the present invention for a monolithic interferometer.

### Non-Identical Prisms

Simulations were performed for the case of non-identical prisms. In one set of simulations, the following angles were employed: β1=β2=112.5°, α1=45+dθ and α2=45−dθ, or, reversely, α1=45−dθ and α2=45+dθ.

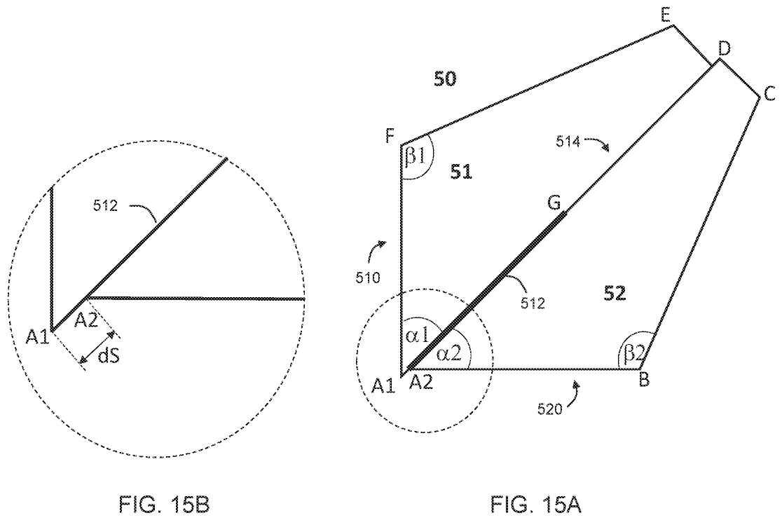

FIGS. 14A and 14B show results of ray tracing simulations performed for the monolithic Sagnac interferometer in a configuration of the interferometer in which the angle of a beam splitter is 45.0333°. The simulations coniform that dθ which is about 10 arcminutes, can provide a total OPD of about 10 μm, which supports about 20 interference fringes on half the plane, for an entry facet of about 50 mm.

Sensitivity analysis was done in order to set the required tolerances on the main parameters of the interferometer. By requiring that each tolerance factor would affect the OPD by no more than 0.5 μm at any of the incidence angles within the simulation range of −0.05 to +0.05 radians (about +/−3 degrees).

Assuming several factors adding randomly, the accumulated effect on any individual manufactured interferometer is expected to be about 1 μm compared to about 10 μm nominal OPD.

The following results were obtained by simulation for a deviation from nominal causing about 0.5 μm of change to OPD:
β1=15 arcseconds (0.25 arcminutes)
β2=15 arcseconds (0.25 arcminutes)

Similarly, a tolerance of α1 of 15 arcseconds, assuming it is not compensated by β1 and thus causes the surface of the top reflector EF to tilt, was found to cause the same effect, where the extra effect on the entry surface is negligible.

Simulations also confirmed that relative offset of one prism along the attachment surface changes the OPD, wherein an offset of 20 μm shift results in a 0.5 μm change of the OPD.

The differences between individual interferometers can be calibrated during system production, affecting mainly the spectral calibration of the system. Since the interferometer is monolithic no recalibration is required after shipment or after temperature changes.

### Identical Prisms, in an Offset Relation

Simulations were performed for the case of identical prisms. In one set of simulations, the following parameters were employed α1=α2=45°, and offset dS of 400 μm (FIGS. 15A and 15B). Simulations show that a an offset of 400 μm creates an OPD of +/−10 μm for entry angle of −/+0.05 radians.

This configuration is advantageous for the standpoint of production accuracy, because as identical prisms are easier to fabricate and the offset of 0.4 mm is relatively easy to control. As the sensitivity remains as simulated above, for a consistent results unit-to-unit the shift should be 400+/−20 μm. Furthermore, the simulation shows that the allowable tolerances of about 15 arcseconds for all prism angles present a similar OPD, within about 10%. Moreover, symmetrical tolerances, as would be created from producing both prisms as part of a single block, have been found to cancel each other and do not affect OPD, thus improving the manufacturability.

The simulation also shows that the OPD depends linearly on the offset dS. On the other hand, the OPD does not depend on the scale of the interferometer, so that a twice larger interferometer can produce the same OPD for the same offset dS and the same input angle. The index of refraction does not affect OPD, as long as it is identical for both prisms. The tolerable difference in refraction index between the prisms that does not significantly change OPD for an entry facet size of about 50 mm is about 5*10⁻⁴ and no more that about 1*10⁻³. A larger difference would result in significantly different OPD, non-linear dependence of OPD on input angle and the output CW and CCW rays may exit the interferometer at different angles. This tolerance scales inversely with the interferometer scale, so that for a twice larger interferometer the tolerable difference is a half. When the two prisms are produced from the same block of optical grade material, this embodiment is easily met.

### Preferred Size of the Beam Splitter

The optimal size for the beam splitter was determined by performing simulations including both a range of input ray angles and a range of input ray positions to the interferometer. For sparse configurations, in which the entrance beam width is significantly smaller than the interferometer size and the angular range is small, the size for the beam splitter can be selected from a wide range of values with no consequence. In more compact configurations, when the cross section of the beam and/or the angular spread are not small compared to the size of the entry facet, the length of the beam splitter is preferably about 80% of the length of the entry facet.

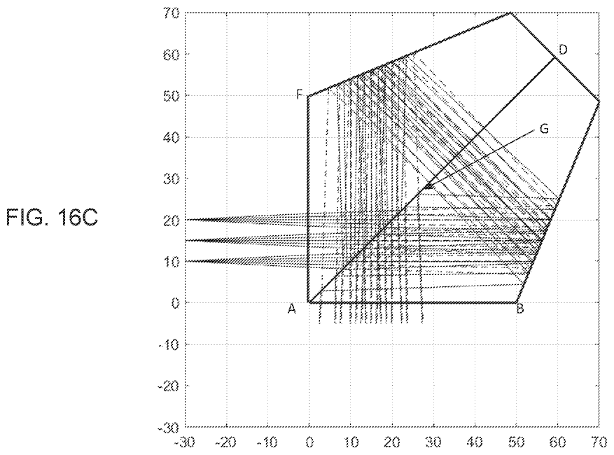

For example, as shown in FIG. 16A, for a beam entering the interferometer around 30% of the height of the entry surface (15 mm from A, along AF, for AF=50 mm), having a width of 20% of AF (10 mm in this configuration) and an angular spread of +/−0.05 radians, a point G can be identified at about 56% of the height, which separates the rays such that all rays meant to go through the beam splitter hit the surface AD below that point and all rays not meant to go through the beam splitter go above. Thus the end of the beam splitter, point G, can be at a distance of 56%*sqrt(2)*length (AF) from the right angle vertex A.

Increasing the angular range to +/−0.075 (FIG. 16B) or removing the source 30 mm away (FIG. 16C) does not significantly change the optimal position for point G.

### Comparison with Michelson-Type interferometer

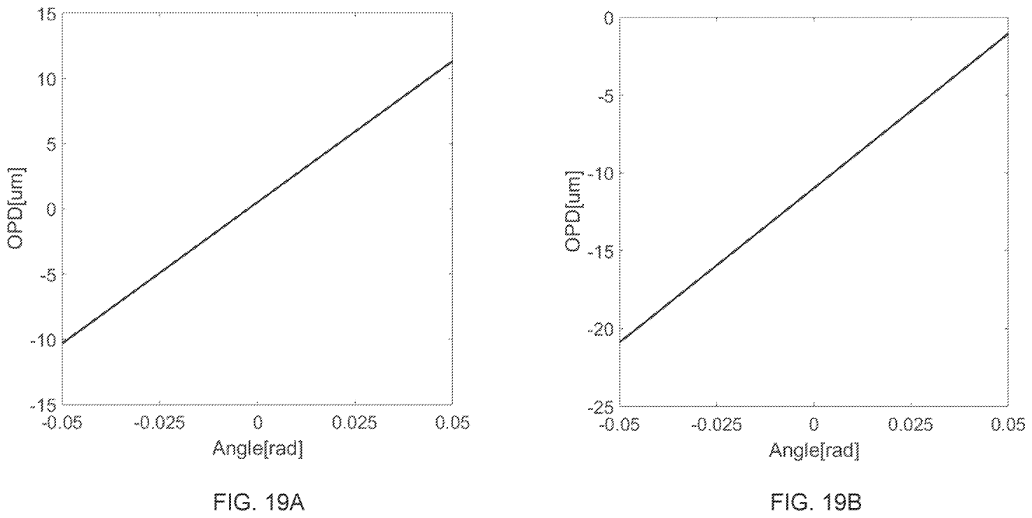

Simulations were conducted as a comparative study between a Michelson-Type monolithic interferometer, illustrated, together with ray tracing simulations, in FIG. 18, and the Sagnac monolithic interferometer of the present embodiments (see, e.g., FIG. 17).

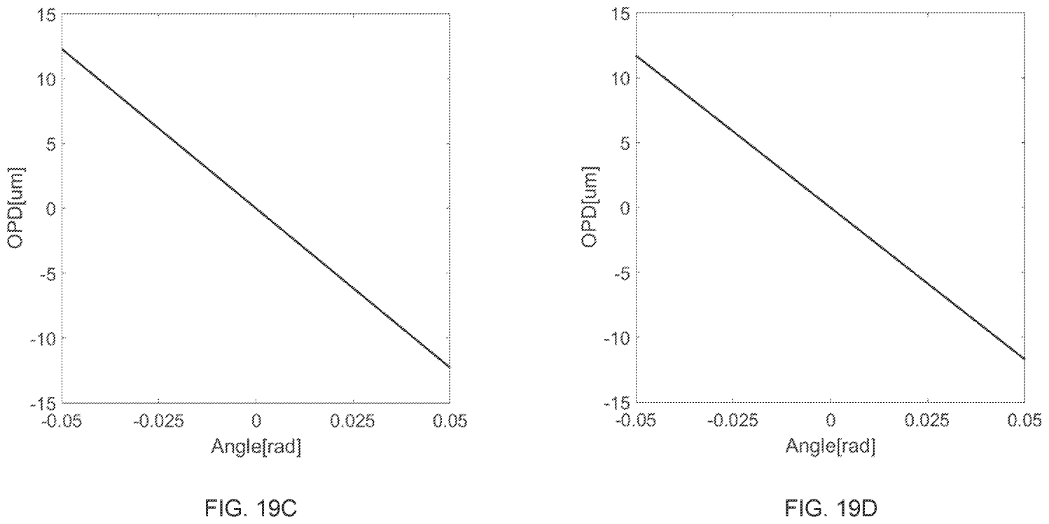

Simulations results for the Michelson-Type monolithic interferometer are shown in FIGS. 19A and 19B, where FIG. 19A shows the OPD as a function of the entry angle for nominal case, and FIG. 19B shows the OPD a function the angle with a 10 μm error in position (slide) between the two prisms. The OPD range in FIG. 19A is 21.6726 μm, and the OPD range in FIG. 19B is 18.8257 μm. As shown in FIG. 19B, OPD=0 is no longer available which is a disadvantage.

Simulations results for Sagnac monolithic interferometer of the present embodiments are shown in FIGS. 19C and 19D, where FIG. 19C shows the OPD as a function of the entry angle for nominal case (an offset dS of 400 μm), and FIG. 19D shows the OPD a function the angle with a 20 μm error in position in the offset (dS=420 μm). The OPD range in FIG. 19C is 24.5928 μm, and the OPD range in FIG. 19B is 23.4217 μm. As shown the production inaccuracy results in a difference of no more that 5% in the range, and OPD=0 is available. Note that the resulting change is symmetrical relative to OCD=0, but this is not necessary, because a situation in which the OPD=0 shifted from the center can in some cases be beneficial, since this extends the maximal absolute OPD. Such a situation may be achieved by rotating the whole interferometer with respect to the input beam, causing the range of input angles to be asymmetrical.

### Example 5

### Analytic Consideration for a Monolithic Sagnac Interferometer

The OPD through the interferometer, with a given sliding shift dS between the two prisms, along the beam splitter surface as shown in FIGS. 15A and 15B

The sliding shift dS results in a normal movement of the reflective surface by an amount, s, which is found to be s=dS*sin(π/4−ϕ)=dS*sin(π/8), where ϕ is the angle of the reflective surface which is typically about π/8 radians, and π/4 radians is the angle of the beam splitters (all angles measured with respect to positive x direction).

A ray reflecting off the surface at angle α is thus shifted by b=s*sin(2α). A secondary ray that is split from a ray entering through the entry facet at angle θ, reflects off the internal reflective surface of the prism at angle ϕ+θ if propagating along the reflective clockwise path or ϕ−θ if propagating along the transmission counter-clockwise path. The effect of the shifting of the mirror creates reverse effect on the two paths.

Thus the total difference in beam positions at the exit surface, Δb, is the sum:

$$\\ Δ b = s * sin ( 2 ( ϕ + θ ) ) + s * sin ( 2 ( ϕ - θ ) )$$

which can be approximated to leading order:

Δb≈s*[sin(2ϕ)+2θcos(2ϕ)+sin(2ϕ)−2θcos(2ϕ)]=2*s*sin(π/4)

Thus, in the leading order, Δb does not depend on the incoming angle θ, since typically the angles are very small, about 0.05 or less, the next order correction can be neglected.

The OPD between the two secondary rays is OPD=Δb*sin(θ). Substituting the above expressions for s and Δb, one obtains:

$$\\ OPD = 2 * dS * sin ( π / 8 ) * sin ( π / 4 ) * sin ( θ ) .$$

Thus, for small values of θ, the OPD is linear with θ and dS.

For typical values, e.g. dS=400 μm and θ=0.05 radians, one obtains OPD=10.8 μm, which is compatible with the simulation in Example 4.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

### REFERENCES

Keren et al., 2018, Cell 174, 1373-1387.
Michaela Aichler and Axel Walch, Laboratory Investigation (2015) 95, 422-431
Y. Garini and E. Tauber, Spectral Imaging: Methods, Design, and Applications in Biomedical Optical Imaging Technologies: Design and Applications, edited by R. Liang (Springer, Heidelberg, 2013).
U.S. Pat. No. 5,539,517
Shmilovich et.al, Scientific Reports, (2020) 10:3455
WO2021/014455 A1

1. A method of imaging a sample, comprising:
serially illuminating the sample by a plurality of light beams, each having a different central wavelength;
by an imager, serially acquiring from the sample image data representing optical signals received from the sample responsively to said plurality of light beams;
shifting a field-of-view of the sample relative to said imager and repeating said serial illumination and said image data acquisitions for said shifted field-of-view; and
generating a spectral image of the sample using image data acquired by said imager at a plurality of field-of-views for each of said plurality of light beams.

2. The method according to claim 1, wherein said serially acquiring image data is while said field-of-view is static.

3. (canceled)

4. The method according to claim 1, wherein said sample contains a plurality of fluorophores each having a different emission spectrum, and wherein a spectral bandwidth of at least one of said light beams is selected to excite at least two different fluorophores.

5-7. (canceled)

8. The method according to claim 1, wherein said illuminating is via beam splitter configured and positioned to reflect said light beams and transmit said optical signals or vice versa.

9-11. (canceled)

12. The method according to claim 1, comprising directing a portion of said optical signal to a spectrometer for measuring a local spectrum of each optical signal, comparing said measured spectra to a local spectrum of said spectral image, and generating a report pertaining to said comparison.

13. (canceled)

14. The method according to claim 1, comprising directing a portion of said optical signal to an additional imager for generating also a non-spectral image.

15-21. (canceled)

22. The method according to claim 1, comprising passing said optical signal through an optical system characterized by optical transmission properties that vary according to the entry angle.

23-33. (canceled)

34. The method according to claim 22, wherein said optical system comprises a Sagnac interferometer.

35. (canceled)

36. The method according to claim 34, wherein said Sagnac interferometer comprises:
two attached prisms forming an asymmetric monolithic structure having an entry facet at one prism and an exit facet at another prism; and
a beam splitter, engaging a portion of an attachment area between said prisms and being configured for splitting said optical signal entering through said entry facet into two secondary optical signals exiting through said exit facet;
wherein a size of said beam splitter is selected to ensure that optical paths of said secondary optical signals impinge on said attachment area both at locations engaged by said beam splitter and at locations not engaged by said beam splitter.

37. (canceled)

38. The method according to claim 36, wherein said two prisms are identical but are attached offset to one another thus ensuring said asymmetry.

39-41. (canceled)

42. The method according to claim 36, wherein said monolithic structure comprises a spacer at said attachment area, spaced apart from said beam splitter away from any of said optical paths.

43-45. (canceled)

46. A method of imaging a pathological slide stained with multiple stains having different spectral properties, comprising:
executing the method according to claim 1;
analyzing said spectral image for a relative contribution of each stain; and
generating a displayable density map of said stains based on said relative contribution.

47-51. (canceled)

52. A system for imaging a sample, comprising:
an illumination system configured for serially illuminating the sample by a plurality of light beams, each having a different central wavelength;
an imager, configured for acquiring image data from the sample, said image data representing optical signals received from the sample responsively to said plurality of light beams;
a stage configured for shifting a field-of-view of the sample relative to said imager;
a controller, configured to control said stage to shift said field-of-view in steps, and to control said illumination system and said imager such said illumination system serially illuminates the sample by said light beams and said imager serially acquires said image data; and
an image processor configured to generate a spectral image of the sample using image data acquired by said imager at a plurality of field-of-views for each of said plurality of light beams.

53-59. (canceled)

60. The system according to claim 52, comprising an optical system positioned on an optical path between the sample and said imager and being characterized by varying optical transmission properties.

61-69. (canceled)

70. A Sagnac interferometer, comprising:
two attached prisms forming an asymmetric monolithic structure having an entry facet at one prism and an exit facet at another prism; and
a beam splitter, engaging a portion of an attachment area between said prisms and being configured for splitting an optical signal entering through said entry facet into two secondary optical signals exiting through said exit facet;
wherein a size of said beam splitter is selected to ensure that optical paths of said secondary optical signals impinge on said attachment area both at locations engaged by said beam splitter and at locations not engaged by said beam splitter.

71. The Sagnac interferometer according to claim 70, wherein said two prisms are identical but are attached offset to one another thus ensuring said asymmetry.

72. The Sagnac interferometer according to claim 70, wherein said two prisms have different shapes thus ensuring said asymmetry.

73. The Sagnac interferometer according to claim 70, wherein said monolithic structure comprises a spacer at said attachment area, spaced apart from said beam splitter away from any of said optical paths.

74. The Sagnac interferometer according to claim 73. wherein said spacer is made of the same material and thickness as said beam splitter.

75. The Sagnac interferometer according to claim 70, wherein said two prisms are attached to form a penta-prism
